(19) United States
(12) Patent Application Publication
(10) Pub. No.: US 2021/0013551 A1
(43) Pub. Date: Jan. 14, 2021

(54) ELECTRICAL ENERGY STORAGE DEVICE, AN ELECTROLYTE FOR USE IN AN ELECTRICAL ENERGY STORAGE DEVICE, AND A METHOD OF PREPARING THE DEVICE

(71) Applicant: City University of Hong Kong, Kowloon (HK)

(72) Inventors: Chunyi Zhi, Shatin (HK); Funian Mo, Kowloon (HK); Longtao Ma, Kowloon (HK); Zijie Tang, Kowloon (HK)

(21) Appl. No.: 16/504,568

(22) Filed: Jul. 8, 2019

(51) Int. Cl. H01M 10/38

(52) U.S. Cl. CPC H01M 10/38; H01M 4/244

(57) ABSTRACT

An electrolyte for use in an electrical energy storage device includes: a hydrogel and an electrolytic solution retained by the hydrogel; and a polymeric layer substantially encapsulating the hydrogel and forming at least one crosslinked structure with the hydrogel; wherein the polymeric layer is arranged to prevent water escaping from the hydrogel structure.

### TECHNICAL FIELD

The present invention relates to an electrolyte, an electrical energy storage device, and a method for preparing the device, in particular, but not exclusively, to a flexible electrolyte used in an electrical energy storage device arranged to prevent water escaping from the electrolyte.

### BACKGROUND

Flexible and wearable devices are growing in use and are starting to become more mainstream. Flexible and wearable devices are being incorporated into wearable products that are also starting to become more popular and are starting to gain a wider usage.

A wearable energy source is a requirement for any wearable device. Wearable energy source devices have attracted tremendous attention due to the rapid development of wearable electronics. Examples of wearable power source may include supercapacitors or some particular batteries.

### SUMMARY OF THE INVENTION

In accordance with the first aspect of the present invention, there is provided an electrolyte for use in an electrical energy storage device, comprising: a hydrogel and an electrolytic solution retained by the hydrogel; and a polymeric layer substantially encapsulating the hydrogel and forming at least one crosslinked structure with the hydrogel; wherein the polymeric layer is arranged to prevent water escaping from the hydrogel structure.

In an embodiment of the first aspect, the at least one crosslinked structure of the polymeric layer includes a first crosslinked structure defined by a plurality of polymer chains of a first polymeric material that form at least one covalent bond with the hydrogel.

In an embodiment of the first aspect, the hydrogel comprises a polymer matrix including at least two crosslinked structures having a second polymeric material and a third polymeric material.

In an embodiment of the first aspect, the plurality of polymer chains of the first polymeric material are functionalized with a first coupling agent such that the polymer chains of the first polymeric material form a covalent bond with a plurality of polymer chains of the second polymeric material defining a second crosslinked structure of the at least two crosslinked structures of the polymer matrix.

In an embodiment of the first aspect, the first coupling agent includes triethoxy(vinyl)silane (TEOVS).

In an embodiment of the first aspect, the first polymeric material is polydimethylsiloxane (PDMS).

In an embodiment of the first aspect, the plurality of polymer chains of the second polymeric material are functionalized with a second coupling agent for coupling with the first coupling agent.

In an embodiment of the first aspect, the second coupling agent includes 3-(trimethoxysilyl)propyl methacrlate (TMSPMA). In an embodiment of the first aspect, the second crosslinked structure is defined by the plurality of polymer chains of the second polymeric material that form a chemical crosslink and/or a physical crosslink between each adjacent pair of polymer chains of the second polymeric material.

In an embodiment of the first aspect, the chemical crosslink includes at least one covalent bond formed at a bonding site between the adjacent pair of polymer chains of the second polymeric material.

In an embodiment of the first aspect, the chemical crosslink further includes a first crosslinking agent forming the at least one covalent bond with the adjacent pair of polymer chains of the second polymeric material. In an embodiment of the first aspect, the first crosslinking agent is N,N′-methylenebisacrylamide.

In an embodiment of the first aspect, the physical crosslink includes a second crosslinking agent forming at least one hydrogen bond with the adjacent pair of polymer chains of the second polymeric material.

In an embodiment of the first aspect, the second crosslinking agent includes ethylene glycol.

In an embodiment of the first aspect, the at least two crosslinked structure includes a third crosslinked structure defined by a plurality of polymer chains of the third polymeric material that form an ionic crosslinked between at least one adjacent polymer chain of the third polymeric material.

In an embodiment of the first aspect, the ionic crosslink includes at least one ionic bond formed at a bonding site between the adjacent pair of polymer chains of the third polymeric material.

In an embodiment of the first aspect, the ionic crosslink further includes a third crosslinking agent forming the at least one ionic bond with the adjacent pair of polymer chains of the third polymeric material.

In an embodiment of the first aspect, the third crosslinking agent includes a cation.

In an embodiment of the first aspect, the second polymeric material is polyacrylamide.

In an embodiment of the first aspect, the third polymeric material is alginate.

In an embodiment of the first aspect, the electrolytic solution includes at least one salt or acid having a concentration of 0.1-3M.

In accordance with the second aspect of the present invention, there is provided an electrical energy storage device, comprising: an anode and a cathode being spaced apart from each other; an electrolyte disposed between the anode and the cathode, the electrolyte comprises a hydrogel and an electrolyte retained by the hydrogel; and a polymeric layer substantially encapsulating the hydrogel and forming at least one crosslinked structure with the hydrogel; wherein the polymeric layer is arranged to prevent water escaping from the hydrogel structure.

In an embodiment of the second aspect, the anode includes zinc metal or polypyrrole.

In an embodiment of the second aspect, the zinc metal includes electrodeposited zinc having a plurality of nanosheets forming a porous nanostructure facilitating charge transport.

In an embodiment of the second aspect, the cathode includes MnO₂, LiMn₂O₄ or polypyrrole.

In an embodiment of the second aspect, the MnO₂ includes electrodeposited MnO₂ having a plurality of interconnected nanoflakes forming a porous nanostructure.

In an embodiment of the second aspect, each of the electrodes further include an encapsulation having the second and the third polymeric materials enclosing the electrodes.

In an embodiment of the second aspect, the at least one crosslinked structure of the polymeric layer includes a first crosslinked structure defined by a plurality of polymer chains of the first polymeric material that form at least one covalent bond with the hydrogel.

In an embodiment of the second aspect, the hydrogel comprises a polymer matrix including at least two crosslinked structures having a second polymeric material and a third polymeric material.

In an embodiment of the second aspect, the plurality of polymer chains of the first polymeric material are functionalized with a first coupling agent such that the polymer chains of the first polymeric material further form a covalent bond with a plurality of polymer chains of the second polymeric material defining a second crosslinked structure of the at least two crosslinked structures of the polymer matrix.

In an embodiment of the second aspect, the plurality of polymer chains of the second polymeric material are functionalized with a second coupling agent for coupling with the first coupling agent.

In an embodiment of the second aspect, the second crosslinked structure is defined by the plurality of polymer chains of the second polymeric material that form a chemical crosslink and/or a physical crosslink between each adjacent pair of polymer chains of the second polymeric material.

In an embodiment of the second aspect, the at least two crosslinked structure includes a third crosslinked structure defined by a plurality of polymer chains of the third polymeric material that form an ionic crosslinked between at least one adjacent polymer chain of the third polymeric material.

In an embodiment of the second aspect, the polymeric layer is arranged to reduce exchange of material between the electrolyte and an external environment, thereby preventing water escaping from the hydrogel structure.

In an embodiment of the second aspect, the device is a rechargeable battery or a supercapacitor.

In accordance of the third aspect of the present invention, there is provided a method of preparing an electrical energy storage device comprising the steps of: a) forming an anode; b) forming a cathode; c) forming an electrolyte comprising a polymer matrix; d) sandwiching the electrolyte between the anode and the cathode; wherein the electrolyte is arranged to prevent water escaping therefrom.

In an embodiment of the third aspect, the step c) of forming an electrolyte comprising a polymer matrix includes the steps of: forming a mixture of a first gel monomer, an initiator, a first crosslinking agent, a second crosslinking agent, and a first coupling agent; adding an alginate into the mixture to form a blend; curing the blend at room temperature or a higher temperature; and soaking the cured blend in an aqueous electrolytic solution.

In an embodiment of the third aspect, the first gel monomer is acrylamide, the initiator is ammonium persulfate, the first crosslinking agent is N,N′-methylenebisacrylamide, the second crosslinking agent is ethylene glycol, and the first coupling agent is 3-(trimethoxysilyl)propyl methacrlate (TMSPMA). In an embodiment of the third aspect, the aqueous electrolytic solution includes at least one of a salt, an acid or a surfactant.

In an embodiment of the third aspect, the step a) of forming an anode includes the step of electrodepositing zinc metal on a substrate.

In an embodiment of the third aspect, the step b) of forming a cathode includes the step of depositing an active material on a substrate.

In an embodiment of the third aspect, the active material includes MnO₂, LiMn₂O₄ and polypyrrole.

In an embodiment of the third aspect, the steps a) and b) include the step of encapsulating the electrodes with the electrolyte.

In an embodiment of the third aspect, the method further includes the step of, after step d), encapsulating the sandwiched structure with a polymeric layer.

In an embodiment of the third aspect, the step of encapsulating the sandwiched structure with a polymeric layer includes the step of immersing the sandwiched structure into a solution of silane-modified polydimethylsiloxane (PDMS).

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein the term ‘and/or’ means ‘and’ or ‘or’, or where the context allows both.

The invention consists in the foregoing and also envisages constructions of which the following gives examples only. In the following description like numbers denote like features.

As used herein “(s)” following a noun means the plural and/or singular forms of the noun.

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that at least some embodiments may be described as a method (i.e. process) that is depicted as a flowchart, a flow diagram, a structure diagram, or a block diagram. Although a flowchart may describe the operations as a sequential method, many of the operations can be performed in parallel or concurrently. In addition, the order of the operations may be rearranged. A method (i.e. process) is terminated when its operations are completed.

In this specification, the word “comprising” and its variations, such as “comprises”, has its usual meaning in accordance with International patent practice. That is, the word does not preclude additional or unrecited elements, substances or method steps, in addition to those specifically recited. Thus, the described apparatus, substance or method may have other elements, substances or steps in various embodiments. The term “comprising” (and its grammatical variations) as used herein are used in the inclusive sense of “having” or “including” and not in the sense of “consisting only of”.

### BRIEF DESCRIPTION OF THE DRAWINGS

Notwithstanding any other forms which may fall within the scope of the present disclosure, a preferred embodiment will now be described, by way of example only, with reference to the accompanying drawings in which:

FIG. 1A illustrates of an electrical energy storage device in accordance with an embodiment of the present invention.

FIG. 1B illustrates a further configuration of the electrical energy storage device of FIG. 1A.

FIG. 2A illustrates a structure of the electrolyte of the electrical energy storage device of FIGS. 1A and 1B.

FIG. 2B illustrates the hydrogen bonding between adjacent pair of polymer chains of a second polymeric material and a second crosslinking agent in the electrolyte of FIG. 2A.

FIG. 2C illustrates the ionic bonding between guluronic acid units of polymer chains of a third polymeric material and a third crosslinking agent in the electrolyte of FIG. 2A.

FIG. 3A is SEM image of an AD-gel electrolyte with a magnification scale of 50

μm.

FIG. 3B is cross-section mapping images and corresponding EDS results of the AD-gel electrolyte.

FIG. 4 is FTIR spectra of the surface and cross section of the AD-gel electrolyte.

FIG. 5A is an optical image showing the transparent appearance of the AD-gel electrolyte.

FIG. 5B is an optical image showing the appearance of the AD-gel electrolyte before and after doped with a blue ink.

FIG. 6A is an optical image showing the effect of ethylene glycol (EG) weight percentage on freezing-resistant performance of the AD-gel electrolyte after being freezed at −20° C. for one day.

FIG. 6B is a plot of freezing temperature against EG content showing the freezing points of the AD-gel electrolyte with various EG weight percentage tested by DSC measurement.

FIG. 7A is a plot of weight percentage against temperature showing TG curves of PAM-hydrogel and AD-gel electrolyte with a temperature range of 25 to 600° C.

FIG. 7B is a plot of heat flow against temperature showing DSC curve of AD-gel electrolyte at a scan rate of 10° C. min⁻¹.

FIG. 8A is an optical image showing elastic stability of the AD-gel electrolyte and/or PAM-hydrogel under twisting and compression after the AD-gel electrolyte and the PAM-hydrogel are stored at various temperatures for one day.

FIG. 8B is a bar chart showing tensile strength of the AD-gel electrolyte and the PAM-hydrogel under normal, cold or hot environments.

FIG. 8C is a plot of tensile strength against strain of the AD-gel electrolyte at 25° C., −20° C., and 80° C.

FIG. 8D is a bar chart showing compression strength of the AD-gel electrolyte and the PAM-hydrogel under normal, cold or hot environments.

FIG. 8E is a plot of compression strength against strain of the AD-gel electrolyte at 25° C., −20° C., and 80° C.

FIG. 9A is a series of optical images showing the appearance of the AD-gel electrolyte and the PAM-hydrogel before and after being stored in open air for 10 or 30 days.

FIG. 9B is a plot of weight ratio against storage time of the AD-gel electrolyte and the PAM-hydrogel corresponding to FIG. 9A.

FIG. 10A is a series of optical images showing the appearance of the AD-gel electrolyte and the PAM-hydrogel after subjecting to freeze-dry or storing at 80° C. for 24 h.

FIG. 10B is a bar chart showing weight retention of the AD-gel electrolyte and the PAM-hydrogel under normal, cold or hot environments.

FIG. 11 is an optical image showing the appearance of the AD-gel electrolyte after being dipped into a dye solution and the appearance of colored AD-gel electrolyte after subsequently being washed with water.

FIG. 12A is a bar chart showing ion conductivity of the AD-gel electrolyte after being stored at 25° C., −20° C. or 80° C. for 24 h or being stored in air for 30 d.

FIG. 12B is a SEM image showing cross section of the AD-gel electrolyte being freeze-dried for 24 h.

FIG. 12C is an impedance spectroscopy (EIS) plot showing AC impedance spectra of the AD-gel electrolyte in a frequency range of 10 kHz to 0.01 Hz under the conditions of 25° C., −20° C. or 80° C. or being stored in air for 30 d.

FIG. 13A is XRD spectra showing XRD pattern of electrodeposited MnO₂.

FIG. 13B is XPS spectra of Mn 3s region of the electrodeposited MnO₂.

FIG. 13C is a SEM image of electrodeposited MnO₂ on stainless steel (SS) mesh with a magnification scale of 10 μm. The insert is a magnified SEM image of FIG. 13C with a magnification scale of 500 nm.

FIG. 13D is a HRTEM image of nanocrystalline MnO₂.

FIG. 13E is a SEM image of electrodeposited zinc on SS mesh with a magnification scale of 2 μm.

FIG. 14 is a schematic illustration showing the fabrication process of AD-battery 1400.

FIG. 15A is a cyclic voltammogram showing cyclic voltammetry (CV) curves of the zinc anode and the MnO₂@SS mesh cathode.

FIG. 15B is a plot of voltage against specific capacity showing the charge-discharge curves at 10^{th} charge-discharge cycle at 0.1 A g⁻¹ of a Zn—MnO₂ battery containing liquid electrolyte (2 mol L⁻¹ ZnSO₄ and 0.2 mol L⁻¹ MnSO₄) and the AD-battery 1400.

FIG. 15C is a cyclic voltammogram showing CV curves of the AD-battery 1400 at different scan rates.

FIG. 15D is a plot showing rate performance of the AD-battery 1400.

FIG. 15E is a plot of voltage against specific capacity showing charge-discharge profiles of the AD-battery 1400 corresponding to FIG. 15D.

FIG. 16A is cyclic voltammogram showing CV curves of the AD-battery 1400 over a temperature range from −20° C. to 80° C.

FIG. 16B is an EIS plot showing impedance spectra of the AD-battery 1400 over a temperature range from −20° C. to 80° C.

FIG. 16C is a plot of voltage against specific capacity showing galvanostatic charge-discharge (GCD) profiles at 5^{th} charge-discharge cycle at 0.2 A g⁻of the AD-battery 1400 over a temperature range from −20° C. to 80° C.

FIG. 16D is a plot showing cycling performance of the AD-battery 1400 at 1.6 A g⁻¹ under a temperature of −20° C. and 25° C.

FIG. 16E is a plot of voltage against time showing voltage profiles of the AD-battery 1400 and a PAM-gel battery along with cyclic cooling and heating processes at a current density of 1.0 A g⁻¹.

FIG. 17 is a pair of bar charts showing specific capacity retentions and energy density at different temperatures.

FIG. 18 is a plot of specific capacity against cycle number showing cycling performance of the AD-battery 1400 and the PAM-battery at 1.0 A g⁻¹under 80° C. The insert is a bar chart showing weight retention of the batteries before and after the cycling tests.

FIG. 19 is a plot of specific capacity against temperature showing cycling performance of the AD-battery 1400 and the PAM-battery at 0.3 A g⁻¹.

FIG. 20 is a plot of capacity retention against storage time of the AD-battery 1400 and the PAM-battery.

FIG. 21A is a set of optical images showing the AD-battery 1400 powering a digital timer while the battery is subjecting to twisting, bending, folding or rolling.

FIG. 21B is plots of voltage against specific capacity of the Ad-battery 1400 upon being bent at different bending angles.

FIG. 21C is a plot of capacity retention against bending cycles of the AD-battery 1400 being bent at 180°.

FIG. 22A is a plot of voltage against specific capacity showing GCD curves of the AD-battery 1400 being immersed in water for different period of time.

FIG. 22B is a plot of capacity retention against soaking time of the AD-battery 1400 being immersed in a solution of blue ink.

FIG. 22C is a plot of capacity retention against soaking time of the AD-battery 1400 being immersed in a solution of beer, soda or redberry juice.

FIG. 23A is an optical image showing the AD-battery 1400 being sealed in an ice while powering a digital timer.

FIG. 23B is a plot of capacity retention against storage time of the AD-battery 1400 working at −20° C. The insert is a plot of voltage against specific capacity showing discharge curves of the AD-battery 1400 at different time intervals corresponding to FIG. 23B.

FIG. 24 is a series of optical images showing the AD-battery 1400 powers a digital timer under boiling water.

FIG. 25A is an EIS plot showing AC impedance spectra of the AD-gel electrolyte containing 2 M ZnSO₄+0.2 M MnSO₄ in a frequency range of 10 kHz to 0.01 Hz under a temperature of −20° C., 25° C. or 80° C.

FIG. 25B is an EIS plot showing AC impedance spectra of the AD-gel electrolyte containing 0.5 M Li₂SO₄ in a frequency range of 10 kHz to 0.01 Hz under a temperature of −20° C., 25° C. or 80° C.

FIG. 25C is an EIS plot showing AC impedance spectra of the AD-gel electrolyte containing 0.5 M H₃PO₄ in a frequency range of 10 kHz to 0.01 Hz under a temperature of −20° C., 25° C. or 80° C.

FIG. 25D is an EIS plot showing AC impedance spectra of the AD-gel electrolyte containing 0.5 M Na₂SO₄ in a frequency range of 10 kHz to 0.01 Hz under a temperature of −20° C., 25° C. or 80° C.

FIG. 26A is a cyclic voltammogram showing CV curves of the zinc anode, MnO₂ cathode, and LMO cathode at 0.3 A g⁻¹.

FIG. 26B is a cyclic voltammogram showing CV curves of a Zn-LMO battery at different temperatures.

FIG. 26C is a plot showing cycling performance of the Zn-LMO battery working at −20° C., 25° C. or 80° C.

FIG. 26D is a plot of voltage against specific capacity showing GCD curves of the Zn-LMO battery corresponding to FIG. 26C at −20° C., 25° C. or 80° C.

FIG. 27 is a schematic illustration of an AD-supercapacitor 2700.

FIG. 28A is a cyclic voltammogram showing CV curves of the AD-supercapacitor 2700 at 100 mV s⁻¹ under different temperatures.

FIG. 28B is a plot of voltage against time showing GCD curves of the AD-supercapacitor 2700 at 1.0 mA s⁻¹ under different temperatures.

FIG. 28C is a bar chart showing continuous reversible changes of capacity retention of the AD-supercapacitor 2700 at different temperatures.

### DETAILED DESCRIPTION OF THE PREFERRED EMBODIMENTS

The inventors have, through their own research, trials and experiments, devised that flexible electronics may be used in a variety of applications in healthcare, military, and other applications. For example, flexible electronics may be used in wearable electronic device components and devices (i.e. wearable electronics), which may include smart fabric materials in the wearable electronics. Preferably, devices including garments made with smart fabrics may be used in a variety of applications such as healthcare to replace bulky instruments and bulky electronic components.

One example of an energy storage device for flexible/wearable electronics is zinc-ion battery (ZIB) which may include advantages such as having much less toxic and flammable materials therein as compared with lithium-ion batteries, therefore may have much less safety and/or health concern to users. ZIB may also be low cost for scaling up as a result of the water-free and/or oxygen-free environment for assembling the battery. In addition, ZIB may have a high specific capacity as a result of multiple electron transfer and a low redox potential of Zn²⁺/Zn.

It is appreciated that nowadays many of the flexible and wearable devices may be used in various harsh environments. For example, an iron foundry worker who always works under a high temperature environment may use a sensor on the clothing to monitor his/her body conditions such as heart rate, pulse rate, body temperature and the like during the work. In some cases, sensors or digital watches may be used under water or conditions with an ice temperature or below. Any electrical energy storage devices such as batteries and supercapacitors that cannot endure said harsh environments would lead to a failure of the device as a consequence of battery/supercapacitor failure.

The inventors have, through their own research, trials, and experiments, devised that the failure of the electrical energy storage devices may be correlated to the stability of the electrolyte. It is appreciated that hydrogel electrolytes have been used various flexible and wearable electrical energy storage devices. Nevertheless, the inventors found that many of the hydrogel electrolytes suffer from failure as a result of the loss of water content from the electrolytes.

For example, water may evaporate from the electrolyte when the device is operated at a high temperature. Even switching to an ambient condition may reduce the evaporation rate of water, the water content of the electrolyte may eventually become zero in long run. In contrast, when the device operates at subzero temperatures, water may easily turn into ice and swell in the hydrogel electrolyte thereby inhibiting ion transportation across the electrolyte. Besides, when the hydrogel electrolyte is operated under water, it may absorb water and swell, resulting in loss of adhesion between electrodes and electrolyte. In addition, the exchange of solute between the electrolyte and water may decrease ion concentration of the electrolyte and therefore lower the electrochemical performance of the device eventually.

Besides, human bodies and organs are soft, curved, and constantly moving, flexible and wearable devices will therefore experience various mechanical forces during routine use, including forces from, for example, stretching, folding, hitting, shearing etc. The device sometimes may even experience accidentally cutting and/or scratching during use. In other words, it is inevitable for the device to experience different deformation and/or damages during routine usage or long-term usage. Furthermore, one desirable feature of a flexible/wearable electronic device may be weather resistant. That is, the device may be operated under harsh environments. For example, it may be desirable for a smart watch being operable under water during diving or being operable in a cold environment with a temperature of ice or even lower.

Accordingly, it may be preferable to provide a hydrogel electrolyte that is capable of retaining its water content under extreme temperature as well as maintaining its mechanical properties under such temperature. It may also be preferable to provide an electrical energy storage device containing said electrolyte such that the device may be operable with stable electrochemical performance under various harsh conditions such as mechanical deformations, and even under ice or boiling water.

In accordance with an example embodiment of the present invention, there is provided an electrical energy storage device that may be operable with stable electrochemical performance under various harsh conditions such as under ice or boiling water. The device may also be capable of physically deforming upon subjecting to an external mechanical load such as folding, rolling, twisting, and the like. The device may include a pair of electrodes and an electrolyte comprising a hydrogel and an electrolytic solution retained by the hydrogel. Preferably, the hydrogel may be encapsulated by a polymeric layer that forms at least one crosslinked structure with the hydrogel. The polymeric layer may prevent water from escaping from the hydrogel structure, allowing the device being operable under the aforementioned harsh conditions.

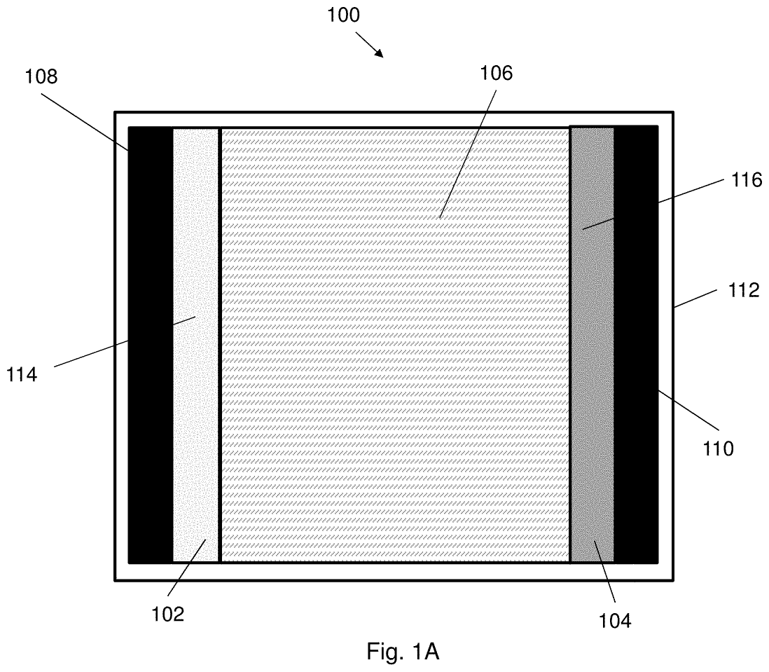

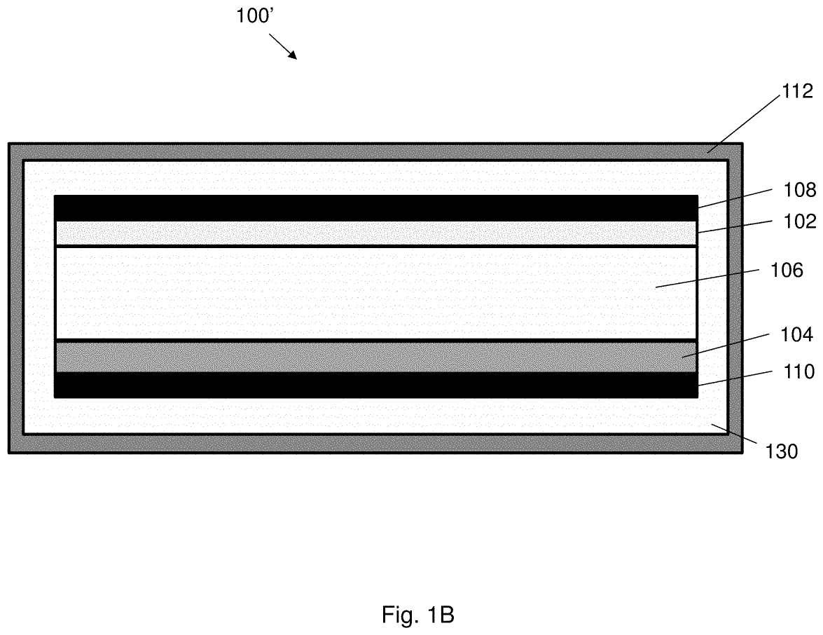

With reference to FIG. 1A, there is shown an exemplary embodiment of an electrical energy storage device 100. The electrical energy storage device 100 may be of any form that can capture energy produced at one time for use at a later time. In one example, the device 100 may be a battery. In another example, the device 100 may be a supercapacitor. In this exemplary embodiment, the electrical energy storage device 100 is a battery, particularly a rechargeable battery. The battery 100 may be of any suitable form that fits a particular application, such as flat-shaped, fiber-shaped, twisted fiber-shaped, coin-shaped, ball-shaped etc. Regardless of the shape of the battery, the battery may substantially have a high resistance to water loss upon subjecting to a dehydration process such as freeze-dry, boiling, and the like. The battery may also be substantially resistant to external mechanical force while the electrochemical performance of the battery is maintained.

In this embodiment, the battery 100 comprises an electrode 102 and an electrode 104 being spaced apart from each other and an electrolyte 106 disposed between the electrodes 102, 104. The electrolyte 106 is sandwiched between and is electrically coupled with the electrodes 102, 104. The electrodes 102, 104 may function as an anode and a cathode, respectively or vice versa.

Optionally or additionally, the battery 100 may also include substrates 108, 110 which may provide mechanical supports to the electrode 102 and/or the electrode 104. The substrates may also operate as a current collector to associate with the electrodes 102, 104, respectively. For example, the substrates may be electrically conductive and may be bonded to external electrical wires to deliver electrical energy to external electronic devices.

The battery 100 may optionally or additionally include an encapsulating layer 112 that receives and encases the electrodes 102, 104 and the electrolyte 106. The encapsulating layer 112 may be formed in any suitable shape such as for example a cylinder or a planar shape or any other suitable shape. The encapsulating layer 112 may be formed from a suitable material such as epoxy or a polymer. Preferably, the encapsulating layer 112 may be capable of preventing water from escaping from the battery.

In one example embodiment, the electrode 102 functions as an anode and the electrode 104 functions as a cathode of the battery 100. In operation there is a charge transfer between the anode 102 and the cathode 104 in order to convert chemical energy to electrical energy. The anode 102 and the cathode 104 are preferably being flexible. The anode 102 and cathode 104 are arranged in a suitable arrangement depending on the desired shape of the battery 100.

With reference to FIG. 1A, the anode 102 comprises a substrate 108 with a metal or metal compound 114 disposed on the substrate 108. The substrate 108 may be of any suitable material. In one example the substrate 108 is a stainless steel (SS) mesh. Alternatively the substrate 108 may be selected from nickel/copper alloy cloth, carbon nanotube (CNT) paper, carbon paper, carbon cloth or steel sheet. The substrate 108 may have some electrical conductance but is preferably robust enough to function within an electrolyte.

The anode 102 preferably comprises zinc. In one example, the anode may be a zinc sheet, particularly a zinc nanosheet 114 that is electrodeposited onto SS mesh 108. The SS mesh 108 provides a base layer for the zinc to be deposited onto. The SS mesh 108 may also have a rough surface which in turn facilitating the deposition of materials thereon. The zinc is deposited to form a substantially thick layer of zinc 114. The thickness may depend on the operational life of the battery 100.

In one example, the electrodeposited zinc may be highly crystalline and uniformly cover the entire surface of the SS mesh. In particular, the electrodeposited zinc may have a highly porous architecture comprising interconnected nanosheets. For example, the nanosheets may be uniformly and vertically arranged on the SS mesh forming a laminated structure. This may be advantageous as the nanocrystalline and porous structure may reduce ion diffusion path which in turn facilitating electrolyte penetration as well as charge/ion transport.

Alternatively the anode 102 may comprise a ribbon or a sheet of zinc metal. That is, the anode 102 may not include an additional substrate 108 and may include a piece of zinc metal. The zinc metal may be a flexible ribbon or a flexible sheet of zinc metal. The zinc metal is arranged in a suitable configuration based on the desired shape of the battery 100.

The cathode 104 comprises a substrate 110 with an active material 116 disposed on the substrate. In one example, the substrate 110 may be in similar construction to the anode substrate 108. That is, the substrate 110 comprises a SS mesh. Alternatively the substrate may be a CNT paper, carbon paper, carbon cloth, nickel/copper alloy cloth or steel sheet.

The active material 116 comprises a metal oxide or a metal oxide compound deposited on the substrate 110. In one example, the active material may be MnO₂ electrodeposited on the SS mesh. The MnO₂ may have a porous structure comprising a plurality of nanoflakes interconnected with each other. The nanoflakes may have a polycrystalline structure comprising a plurality of nanograins with a size of, for example, approximately 10 nm. Similar to the nanocrystalline and porous structure formed by the electrodeposited zinc, the porous nanostructural architecture of the electrodeposited MnO₂ may reduce ion diffusion path which in turn facilitating electrolyte penetration as well as charge/ion transport.

Alternatively, the cathode 104 may comprise other active materials such as LiMn₂O₄ or polypyrrole deposited or electroplated onto substrate 110.

In one example, each of the anode 102 and the cathode 104 may be enclosed by an encapsulation 130 (not shown). That is, the anode 102 and the cathode 104 may be in contact with the electrolyte 106 through the encapsulation 130. The encapsulation 130 on the one hand may function as an electrode protector by dissipating the energy applied thereonto. On the other hand, the encapsulation 130 may synergistically work with the electrolyte 106 so as to dissipating the energy applied on the battery 100, maintaining the integrity and durability of the battery.

The encapsulation 130 may include a polymer or polymer matrix. The polymer or polymer matrix may have certain electrical conductivity and at least some degree of flexibility and mechanical resistance. In one example, the encapsulation may be a polymer matrix having the same composition as the electrolyte 106. For example, the encapsulation may have the same polymeric materials and electrolytic solution that constitute the electrolyte 106. That is, each of the anode and cathode is enclosed by a separate encapsulation 130 having the same composition as the electrolyte 106. Alternatively, the anode and the cathode may be directly enclosed in the electrolyte 106. In other words, the anode and the cathode are positioned within the electrolyte 106.

In yet another example, the encapsulation 130 may not have the same composition as the electrolyte 106. That is, for example, the encapsulation 130 may have the same electrolytic solution as the electrolyte 106 but different polymeric materials.

The electrolyte 106 may be a polymeric electrolyte disposed between or containing the anode 102 and the cathode 104. Preferably, the polymeric electrolyte 106 may be a hydrogel electrolyte that is viscous enough to be formed into a shape and retain the shape it is formed into. For example, the electrolyte 106 may be formed into any one of an elongated shape, a planar shape, a tubular shape, a ball shape or any suitable shape.

The hydrogel electrolyte may comprise a polymer matrix including at least two crosslinked structures having at least two polymeric materials. The polymer material(s) may be chemically functionalized so as to form a covalent bond with the encapsulating layer 112, thereby the hydrogel electrolyte may be substantially encapsulated by the encapsulating layer 112 and preventing water losing from the hydrogel.

The hydrogel electrolyte 106 may include an electrolytic solution containing an aqueous electrolytic solution particularly a salt solution containing at least one ion of Li⁺, Na⁺, Ca²⁺, Mg²⁺, Zn²⁺, Al³⁺, or Fe²⁺. The concentration of ions in the salt solution may be of 0.1-3 M. In another example, the hydrogel electrolyte 106 may include an electrolytic solution containing at least one acid of H₃PO₄, H₂CO₃, CH₃COOH or HF. The concentration of acids in the electrolytic solution may be of 0.1-3 M. A skilled person may recognize any other electrolytic solutions including suitable salts, ions or acids according to their needs.

The electrolyte 106 may be flexible and may dissipate at least some mechanical energy when subjected to an external mechanical load applied to the battery 100, thereby allowing the battery 100 to maintain its electrochemical performance while under deformation. For example, the battery 100 may physically deform into different irregular shapes under the conditions of bending, folding, squeezing, twisting, cutting, and hammering while dissipating energy therefrom, and maintaining the electrochemical performance. In other words, the electrolyte may be capable of withstanding a certain amount of mechanical forces applied thereto while the integrity of the electrolyte and thereby the battery is maintained.

With reference to FIG. 1B, there is provided an alternative configuration of battery 100 (i.e. battery 100′). The battery 100′ may have a similar configuration to the battery 100 in view of electrodes and electrolyte. The battery 100′ may have an anode 102 and a cathode 104 being spaced apart from each other. Each of the electrodes 102, 104 may also include a substrate 108, 110 supporting the electrodes. The electrolyte 106 is sandwiched between the electrodes 102, 104.

The battery 100′ may include an encapsulation 130 enclosing the sandwiched structure (i.e. anode 102, electrolyte 106, and cathode 104). In this example, the encapsulation 130 may include the same composition that constitutes the electrolyte 106. That is, the encapsulation 130 may have the same polymeric material(s) and electrolytic solution as the electrolyte 106. Under this arrangement, the electrodes 102, 104 are equivalent to be enclosed/wrapped by the electrolyte 106.

The battery 100′ may also include an encapsulating layer 112 located at the outer surface of the battery. The encapsulating layer may be a polymeric layer such as an elastomeric layer encapsulating the battery. The elastomeric layer may form at least one crosslinked structure with the electrolyte 106 such that the elastomeric layer is directly coated on surface of the hydrogel electrolyte 106. In this example, the elastomeric layer 112 may form at least one crosslinked structure, such as a chemical crosslinked structure with the encapsulation 130, which has the same composition as the electrolyte 106, thereby encapsulating the battery 100′.

The elastomeric layer may function as a substantially blocking layer which reduces exchange of material between the electrolyte and an external environment. In other words, with the use of the elastomeric layer, on the one hand, the materials from the battery (e.g. water, ions, etc.) may be difficult to move to the external environment; and on the other hand, external materials may also be difficult to move into the battery. This blocking feature may be advantageous as the electrochemical performance of the battery may not be easily deteriorated owing to the loss of battery materials such as water or the entry of external materials that could cause damage to the battery structure during operation.

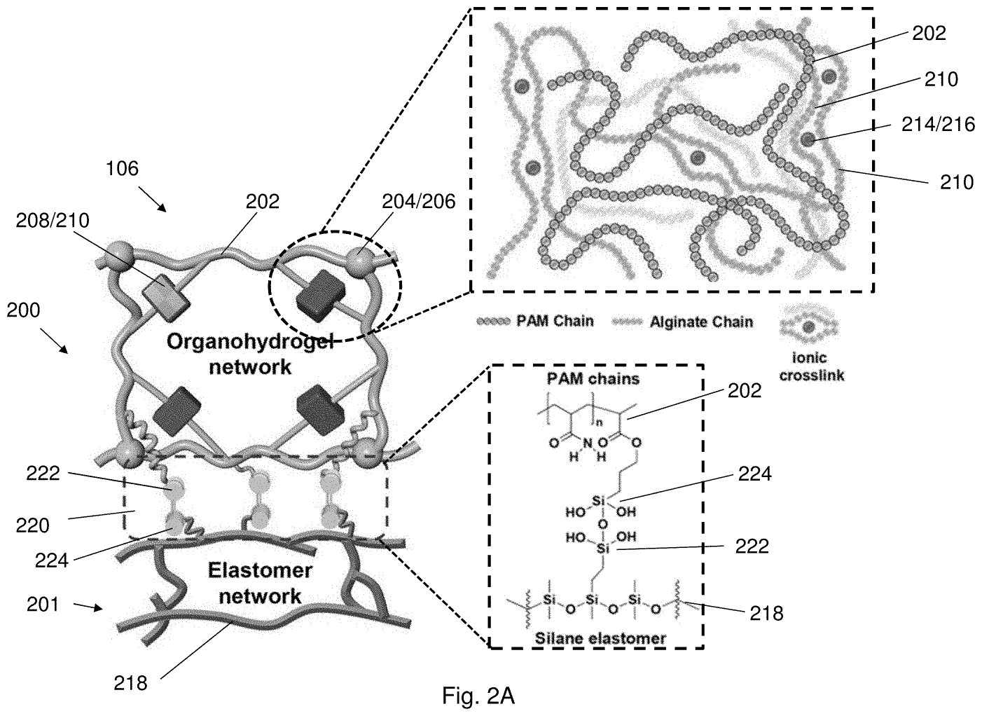

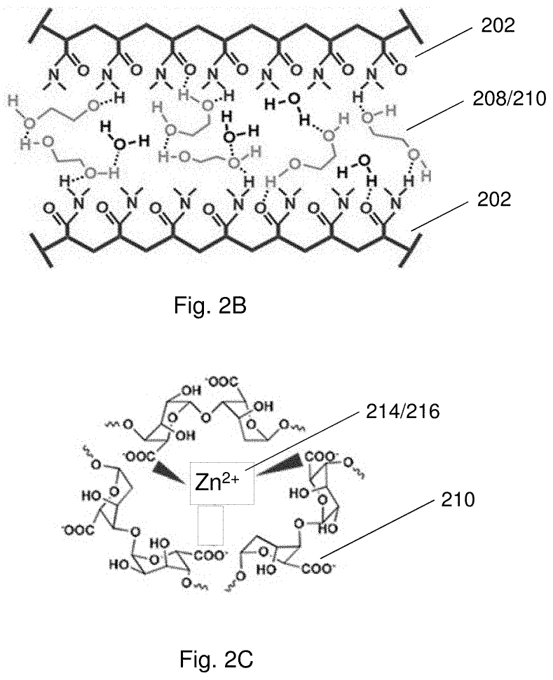

The detailed structural arrangement of the electrolyte 106 will now be described. With reference to FIG. 2A, the electrolyte 106 comprises a hydrogel 200 and a polymeric layer 201 forming at least one crosslinked structure with the hydrogel, thereby substantially encapsulating the hydrogel.

In this example, the polymer layer may comprise a plurality of polymer chains of a first polymer material that form at least one covalent bond with the hydrogel, forming a first crosslinked structure with the hydrogel. The hydrogel 200 may comprise a polymer matrix including at least two crosslinked structures having a second polymeric material and a third polymeric material.

In particular, the first polymeric material and the second polymeric materials and/or the third polymeric material may be chemically functionalized such that the hydrogel 200 and the polymeric layer 201 may be chemically crosslinked with each other.

In one example, the first polymeric material may be polydimethylsiloxane (PDMS) forming an elastomeric layer. The second and the third polymeric material may be polyacrylamide (PAAm) and alginate respectively, which combine and form a hydrogel material that may have an interconnected porous structure and may be used as an electrolyte in a battery or a supercapacitor.

Referring to FIG. 2A, the polymer matrix 200 may include at least a second crosslinked structure and a third crosslinked structure. Each of the crosslinked structures may be defined by a plurality of polymer chains of the second or the third polymeric material. The polymer chains may interact with each other so as to allow the electrolyte to physically deform and dissipate mechanical energy upon subjecting to an external mechanical load applied to the polymer matrix.

The second crosslinked structure is defined by a plurality of polymer chains of the second polymeric material 202 that form a chemical crosslink between each adjacent pair of polymer chains of the second polymeric material 202. The chemical crosslink may include at least one covalent bond that is formed in different ways. In one example, the chemical crosslink may include at least one covalent bond formed at a bonding site 204 between the adjacent pair of polymer chains of the second polymeric material 202.

For example, the chemical crosslink may include a first crosslinking agent 206, such as methylenebisacrylamide (MBAA) crosslinker, which forms at least one kind of covalent bonds with each of the adjacent pair of polymer chains of the second polymeric material 202 or PAAm. Preferably, the crosslinking agent may act as an anchor for bonding the adjacent pair of polymer chains of the second polymeric material together so as to strengthen the robustness of the structure. That is, the second crosslinked structure comprises a plurality of polymer chains of the second polymeric material covalently bonded together via the first crosslinking agent 206.

The second crosslinked structure may be optionally or additionally defined by the plurality of polymer chains of the second polymeric material 202 that form a physical crosslink between each adjacent pair of polymer chains of the second polymeric material 202. The physical crosslink may include at least one hydrogen bond that is formed at a bonding site 208 between the adjacent pair of polymer chains of the second polymeric material 202.

In one example, the physical crosslink may include a second crosslinking agent 210 such as ethylene glycol (EG), which forms at least one hydrogen bond with each of the adjacent pair of polymer chains of the second polymeric material 202 or PAAm. The second crosslinking agent may provide additional linkages between each of the adjacent pair of polymer chains of the second polymeric material which may in turn further strengthen the second crosslinked structure.

The second crosslinking agent 210 may be arranged to provide an anti-freezing effect to the electrolyte 106. As shown in FIG. 2B, the second crosslinking agent may further form at least one hydrogen bond with water molecules. In other words, the water molecules are “held” by the second crosslinking agent, rendering the water molecules more distant from each other. As such, it would be more difficult for the water molecules to get close enough to crystallize (i.e. forming ice) under subzero temperatures, increasing the resistance of the electrolyte to freezing conditions.

Referring back to FIG. 2A, the third crosslinked structure of the polymer matrix 200 is defined by a plurality of polymer chains of the third polymeric material 212 that form an ionic crosslink between each adjacent pair of polymer chains of the third polymeric material 212 or alginate. The ionic crosslink may include at least one ionic bond formed at a bonding site 214 between the adjacent pair of polymer chains of the third polymeric material 212.

For example, the ionic crosslink may include a third crosslinking agent 216, which may include a cation selected from at least one of Ca²⁺, mg²⁺, Zn²⁺, Al ³⁺, Mn²⁺or Fe²⁺. These divalent and/or trivalent ions form at least one ionic bond with each of the adjacent pair of polymer chains of the third polymeric material 210 or alginate. In other words, the ionic bond formed between each of the adjacent pair of polymer chains of the third polymeric material 210 or alginate may include a single type of cation and/or a combination of different types of cation.

The third crosslinking agent 216 may, on the one hand, partially act as an anchor for bonding the adjacent pair of polymer chains of the third polymeric material together so as to strengthen the robustness of the structure. For example, the third crosslinking agent 216 may form at least one ionic bond with a specific functional group of the polymer chains of the second polymeric material. As shown in FIG. 2C, the third crosslinking agent may form two hydrogen bonds with the guluronic acid units of the polymer chains of the third polymeric material 210. On the other hand, the ionic bonding may reversibly break down upon receiving external mechanical load/stress applied to the polymer matrix, thereby dissipating the applied mechanical loads. The bonding may also reform rapidly which in turn allowing the crosslinked structure to reestablish quickly thereby minimizing any structural expansion when the electrolyte is operated under water. That is, the third crosslinked structure comprises a plurality of polymer chains of the third polymeric material ionically bonded together via the third crosslinking agent 216.

Optionally or additionally, the covalently crosslinked structure may be crosslinked with the ionically crosslinked structure through physical interactions such as intertwining and intercrossing between the polymer chains of the second polymeric material and the third polymeric material. By which the mechanical robustness of the hydrogel may be further increased.

The polymeric layer 201 may comprise a plurality of polymer chains of the first polymeric material 218 or PDMS forming at least one covalent and/or physical crosslink defining a chemical and/or physical crosslinked structure. For example, the molecules of each of the adjacent pair of polymer chains of the first polymeric material may be chemically crosslinked by one or more covalent bonds formed directly between molecules in each of the polymer chains of the first polymeric material 218.

Additionally, the polymer chains of the first polymeric material 218 may be physically crosslinked with each other by intertwining as well as intercrossing with each other, forming an additionally physically crosslinked structure.

As mentioned above, the polymeric layer 201 may form at least one crosslinked structure with the hydrogel 200 so as to substantially encapsulating the hydrogel. With reference to FIG. 2A, the polymeric layer and the hydrogel may form at least a first crosslinked structure defined by the plurality of polymer chains of the first polymeric material and the third polymeric material forming at least one covalent bond at a bonding site 220 between the adjacent pair of polymer chains of the first and the third polymeric materials 218, 202.

Preferably, each of the polymer chains of the first polymer and the third polymeric materials 218, 202 may be functionalized with a first coupling agent 222, a second coupling agent 224, or the combination thereof. In one example, the polymer chains of the first polymeric material and the third polymeric material may be functionalized with the first coupling agent 222 and the second coupling agent 224, respectively. In another example, each of the polymer chains of the first and the third polymeric materials may be functionalized with both the first coupling agent 222 and the second coupling agent 224. In this example, the polymer chains of the first polymeric material 218 may be functionalized with the first coupling agent 222 while the polymer chains of the third polymeric material 202 may be functionalized with the second coupling agent 224.

The coupling agents may be of any suitable chemical compounds that can provide at least one chemical bond between two dissimilar materials. In particular, the coupling agents may be a silane-type coupling agent. The polymer chains of the first polymeric material may be functionalized with a first coupling agent of triethoxy(vinyl)silane (TEOVS); whereas the polymer chains of the third polymeric material may be functionalized with the second coupling agent of 3-(trimethoxysilyl)propyl methacrlate (TMSPMA).

At the bonding site 220, the first coupling agent 222 or TEOVS and the second coupling agent 224 or TMSPMA may be hydrolysed by any suitable method. The hydrolysed coupling agents 222, 224 may condensate with each other by forming a covalent bond such as a siloxane bond therebetween. As such, any molecules along the polymer chain of the first polymeric material and the third polymeric material functionalized with the coupling agents 222, 224 may form a covalent or siloxane bond therebetween, thereby allowing the polymeric layer coating on and encapsulating the hydrogel structure.

The hydrogel 200 is arranged to retain an electrolytic solution therein for ion conductivity. The electrolytic solution may include at least one salt, in particular a metal salt, or an acid or an anti-freezing agent as additives within the electrolytic solution. In one example, the at least one salt, acid, anti-freezing agent may further function as a crosslinking agent for the covalent and/or ionic crosslinked structures. Preferably, the electrolytic solution may include zinc(II) sulphate (ZnSO₄), manganese(II) sulphate (MnO₂), Li₂SO₄ and/or H₃PO₄. A skilled person may recognize any other electrolytic solutions including suitable salts or acids according to their needs.

Referring to FIG. 2A, there is shown an example structure of electrolyte 106 illustrating the crosslinked structures within the electrolyte. As mentioned above, the electrolyte 106 comprises a hydrogel including a polymer matrix having at least two crosslinked structures. The electrolyte also comprises a polymeric layer forming at least one crosslinked structure with the hydrogel such that the hydrogel is substantially encapsulated by the polymeric layer.

In this example, the polymeric layer is an elastomeric layer comprising PDMS (i.e. the first polymeric material). The PDMS chains is arranged to form at least one covalent bond with the hydrogel, forming a first crosslinked structure. The hydrogel includes a polymer matrix having a second crosslinked structure and a third crosslinked structure. Each of the crosslinked structures are defined by a plurality of polymer chains of polyacrylamide (PAAm) (i.e. the second polymeric material) or alginate (i.e. the third polymeric material). The PAAm and PDMS are chemically functionalized such that the hydrogel and the polymeric layer are chemically crosslinked with each other. The second crosslinked structure includes a plurality of PAAm chains crosslinked together by forming covalent bonds with a crosslinking agent such as N,N′-methylenebisacrylamide (MBAA) at a particular bonding site. In particular, the bonding site is where the reaction of the amide group of the PAAm chains and the amide groups of MBAA to occur. The MBAA may act as an anchor to bridge the PAAm chains and as a stress buffer center to dissipate mechanical energy and homogenize the PAAm structure.

The second crosslinked structure also includes a plurality of PAAm chains crosslinked together by forming hydrogen bonds with a crosslinking agent such as ethylene glycol (EG) at a particular bonding site as shown in FIG. 2B. The bonding site is where the interaction between the amide group of the PAAm chains and hydroxyl group of the EG to occur. The EG may further interact with water molecules by forming at least one hydrogen bond with the water molecules. As such, the water molecules are kept apart from each other and prevented from crystallization (i.e. forming ice) when the electrolyte is subjected to subzero temperatures.

The third crosslinked structure includes a plurality of alginate chains crosslinked together by forming ionic bonds with ionic crosslinking agents such as Zn²⁺ and/or Mn²⁺ in the electrolyte. The ionic bonds form when alginate is immersed in an electrolytic solution. Preferably, as shown in FIG. 2C, the bonding site is where the interaction between the guluronic acid units in different alginate chains and the ionic crosslinking agents such as Zn²⁺ and/or Mn²⁺ to occur, in which the negatively charged carboxyl group of the dissociated acid unit in each of the alginate chain forms ionic bonds with the cation. In addition, as alginate includes multiple guluronic acid units, therefore multiple alginate chains may be crosslinked together with such ionic linkages formed by the cations and the carboxyl groups in each of the alginate chains.

The ionic bonds may act as a reversible crosslinking point that can dynamically break/rupture and reform/restore to dissipate mechanical energy upon subjecting to external mechanical loads. The rapid reformation or restoration of the ruptured bonds may further minimize the structural expansion of the electrolyte when it is operated under water.

The polymeric layer comprises a plurality of PDMS chains 218. The PDMS chains may directly form one or more covalent bond between the silane molecules of adjacent PDMS chains, forming a chemically crosslinked structure. The PDMS chains may also intertwine and intercross with each other to form a physically crosslinked network.

The polymeric layer encapsulates the hydrogel by forming the first crosslinked structure defined by the PDMS chains and the PAAm chains forming at least one covalent bond between the PDMS chains and the PAAm chains. Preferably, the PDMS chains are functionalized with TEOVS (i.e. first coupling agent) whereas the PAAm chains are functionalized with TMSPMA (i.e. second coupling agent)such that the PDMS chains can couple with the PAAm chains through the reaction between TEOVS and TMSPMA. In particular, the alkoxy groups of the TEOVS and the TMSPMA are hydrolysed to silanol groups and condensate with each other by forming siloxane bonds therebetween. Any molecules along the PDMS chain and the PAAm chain functionalized with TEOVS and TMSPMA may form a siloxane bond therebetween and therefore in this way, the polymeric layer is coated on and encapsulating the hydrogel structure.

The electrical energy storage device of the present disclosure such as the battery 100 or a supercapacitor 100 may be fabricated by commencing at the step of fabricating the electrodes. It may be the step of forming an anode. In one example, the anode may be a zinc anode. The zinc anode may be prepared by electrodepositing zinc metal onto a substrate. Preferably, the substrate is a SS mesh. Alternatively, the substrate may be selected from carbon cloth, carbon nanotube (CNT) paper, carbon paper, nickel/copper alloy cloth or steel sheet. The electrodeposition time may depend on the thickness requirement, which may depend on the operational life of the electrical energy storage device.

The electrodeposition may be performed by any suitable methods. For example, the electrodeposition may be a facile electrochemical deposition performed with a two-electrode setup. In operation, the substrate such as a SS mesh may be used as a working electrode while a zinc metal foil (purity>99.99%, Suzhou TanFeng Technology Co., Ltd.) may be used as both counter and reference electrodes. An aqueous solution containing for example 1 mol L⁻¹ of ZnSO₄ and 1 mol L⁻¹ KCl (AR grade, Sigma) may be used as the electrolyte. The electroplating may be performed at a predetermined current density (e.g. 10 mA cm⁻²) for a predetermined time (e.g. 1 h) using an electrochemical workstation (CHI 760D).

In another example, the anode may be a conductive polymer deposited on a substrate. In particular, the anode may be a conductive polymer of polypyrrole (PPy) electrodeposited on a SS CNT paper. Alternatively, the PPy may be electrodeposited on carbon cloth carbon paper, nickel/copper alloy cloth, steel sheet, and the like. The electrodeposition may be carried out in an electrochemical setup containing a solution of 0.1 M p-toluenesulfonic acid (AR, Aladdin), 0.3 M sodium toluenesulfate (AR, Sigma-Aldrich), and 0.5% pyrrole monomer (AR, Sigma-Aldrich). The electrodeposition may be performed at a predetermined voltage (e.g. 0.8 V vs Ag/AgCl) for a predetermined time (e.g. 10 min) at 0° C.

In the step of forming a cathode, it may include the step of electrodepositing an active material onto a substrate. In one example, the cathode may be a MnO₂ cathode and the active material MnO₂ is electrodeposited onto a SS mesh. The electrodeposition may be carried out in a three-electrode cell. In operation, the SS mesh may be used as a working electrode while a zinc metal foil (purity>99.99%, Suzhou TanFeng Technology Co., Ltd.) may be used as both counter and reference electrodes. An aqueous solution containing for example 2 mol L⁻¹ of ZnSO₄ and 0.2 mol L⁻¹ MnSO₄ (AR grade,

Sigma) may be used as the electrolyte. The three-electrode cell may be galvanostatically charged to a predetermined voltage (e.g. 1.8 V vs Zn/Zn²⁺) under a predetermined current density (e.g. 0.2 mA cm⁻²). The voltage may be maintained by a predetermined of time such as 8 h using am electrochemical workstation (CHI 760D). After that, the MnO₂ cathode may be dried at an elevated temperature such as in a vacuum oven with a temperature of 80° C.

In another example, the cathode may be a PPy cathode in which the active material PPy is electrodeposited onto a CNT paper using the same procedure as the PPy anode.

In yet another example, the cathode may be a LiMn₂O₄ (LMO) cathode. The active material LMO may be deposited on a substrate such as SS mesh. In particular, the LMO may form a slurry with a conductive material and a binder under a predetermined weight ratio with an aid of a solvent. In this example, the solvent, the conductive material, and the binder may be acetone, acetylene blacks, and polytetrafluoroethylene (PTFE), respectively. The slurry may be uniformly deposited onto the SS mesh using a blade.

It is appreciated that the steps of forming the anode and the cathode may be reversed (i.e. forming the cathode prior to forming the anode) or may be performed simultaneously.

The steps of forming the anode and the cathode may further include the step of encapsulating the anode and the cathode with an electrolyte. The electrolyte, particularly a hydrogel electrolyte comprising a polymer matrix may be prepared by forming a mixture of a first gel monomer, an initiator, a first crosslinking agent, a second crosslinking agent, and a first coupling agent. In this example, the polymer matrix is a matrix of PAAm and alginate. The first gel monomer is acrylamide, the initiator is ammonium persulfate, the first crosslinking agent is N,N′-methylenebisacrylamide (MBAA), the second crosslinking agent is ethylene glycol (EG), and the first coupling agent is 3-(trimethoxysilyl)propyl methacrlate (TMSPMA).

Preferably, the mixture is formed by dissolving 3 g of acrylamide monomer (99%, Sigma-Aldrich) into 20 mL 30% EG solution. The solution is then added with 14.3 mg of ammonium persulphate (APS, >98%, Acros Organics) and 0.16 mL of 0.1 mol L ⁻¹ MBAA (99%, Sigma-Aldrich). After that, 76 μL of TMSPMA (99%, Sigma-Aldrich 440159) is added to the mixture under vigorously stirring. The mixture may then be added with an alginate (i.e.

second polymeric material) to form a blend. The blend may be degassed to remove any air bubbles therein, facilitating the subsequent curing process. In this example, 0.358g of alginate (AR grade, Sigma-Aldrich) is added to the mixture under stirring until a clear blend solution is obtained. The solution may be degassed for 10 min by ultrasonication.

The as-obtained blend may be cured to form a hydrogel. The curing process may be performed at room temperature or a higher temperature to allow polymerization. The curing process may be carried in a glass mould. In this example, the degassed blend may be cured in a planar or column mold under UV radiation (360 nm) at room temperature for 2h in order to allow free radical polymerization of the PAAm chains as well as the polymerization between the TMSPMA and the PAAm chains.

At this stage, the as-obtained hydrogel includes covalently crosslinked PAAm network functionalized with TMSPMA with un-crosslinked alginate chains dispersed among the PAAm network. The as-prepared hydrogel may be peeled off and optionally dried under room temperature or an elevated temperature.

The cured hydrogel may then be soaked into an aqueous electrolytic solution to promote ion conductivity of the electrolyte and the formation of the ionic crosslinked structure. In one example, the aqueous electrolytic solution may include at least one of a salt, an acid or a surfactant as additives.

In this example, the cured hydrogel may be soaked into an aqueous electrolytic solution containing zinc(II) sulphate at a concentration of for example 2 mol L⁻¹ and manganese(II) sulphate at a concentration of for example 0.2 mol L⁻¹, 30 wt % of EG, and 0.1 mol L⁻¹ of sodium dodecyl sulfate (SDS) (i.e. surfactant) for 1 h at room temperature. This may allow ion exchange between the internal of hydrogel and the external solution. In addition, the ionic crosslinks may form between adjacent alginate chains through the interactions with Zn²⁺ and/or Mn²⁺ ions. Also, any excess Zn²⁺ and/or Mn²⁺ ions may contribute to ion transport for the electrolyte. Furthermore, the surfactant may facilitate the solvation and hydrolysis of the coupling agents in the interfacial layer of the aforementioned hydrogel 200 and the polymeric layer 201, thereby facilitating the coupling reaction therebetween.

Alternatively, the electrolytic solution may contain other salts, acids or the combination thereof in addition to the EG and SDS. In one example, the electrolytic solution may contain zinc(II) sulphate at a concentration of for example 2 mol L ⁻¹ and Li₂SO₄ at a concentration of for example 0.5 mol L⁻¹. In another example, the electrolytic solution may contain H₃PO₄ at a concentration of for example 2 wt %.

Turning back to the step of encapsulating the anode and the cathode with the electrolyte. The anode and the cathode may be encapsulated by the electrolyte separately by immersing the anode or the cathode into the blend as mentioned above, followed by the step of curing the blend at room temperature or a higher temperature and soaking the cured blend in an aqueous electrolytic solution. As such, each of the anode and the cathode would be encapsulated by an electrolyte, forming an encapsulated anode and an encapsulated cathode.

The encapsulated anode and the encapsulated cathode may then sandwich the electrolyte by depositing the encapsulated anode and the encapsulated cathode onto the opposite sides of the electrolyte, forming a sandwiched structure with the anode and the cathode being wrapped inside the electrolyte.

Alternatively, the step of encapsulating the anode and the cathode may be performed simultaneously with the step of forming the electrolyte. In turn, the anode and the cathode would be encapsulated and wrapped inside the electrolyte upon the step of curing the blend.

The method may further include the step of encapsulating the sandwiched structure with a polymer layer after obtaining the sandwiched structure. In particular, the encapsulation step may include the step of immersing the sandwiched structure into a solution of silane-modified PDMS. In this example, the solution may contain a Pt catalyst with a concentration of for example 0.1% v/w and a silane-modified PDMS precursor. The silane-modified PDMS precursor may include a curing agent of Sylgard 184 (Dow Corning) and a liquid base at a weight ratio of 10:1, and TEOVS (i.e. second coupling agent).

The sandwiched structure may be repeatedly immersed into the solution of silane-modified PDMS for at least 5 times so to have sufficient amount of the solution retaining on the surface of the sandwiched structure. The structure containing the solution may then dried at an elevated temperature such as 65° C. for 2 h. At this stage, an electrical energy storage device being encapsulated with a polymeric layer is obtained.

The characterization and performance of embodiments of the electrolyte and the electrical energy storage device containing said electrolyte will now be discussed. Structural and phase characterizations of the as-prepared electrodes were performed by XRD using a Bruker D2 Phaser diffractometer with Cu Kα irradiation (λ=1.54 Å. The surface morphology of these samples was characterized by an environmental scanning electron microscope (ESEM, FEI/Philips XL30). The morphology and microstructure of the samples were revealed by a JEOL-2001F field-emission TEM.

Electrochemical performance of the fabricated AD-gel Zn—MnO₂ battery were examined based on galvanostatic testing in the voltage range of 0.8-1.85 V using a Land 2001A battery testing system. The volumetric energy density (E) of the full battery was calculated by

E=∫₀^{t}Iv₍ₜ₎dt/V

where I is the discharge current, V₍ₜ₎ is the discharge voltage at time t, dt is time differential, and V is the total volume of the whole solid-state device, which is calculated by multiplying the surface area and the thickness of the batteries.

Cyclic voltammetry and electrochemical impedance spectroscopy (100 kHz to 0.1 Hz) were conducted by an electrochemical workstation (CHI 760D). The ionic conductivity of polymer electrolyte can be calculated by ohmic resistance, which can be obtained from the AC impedance spectra. The equation of ionic conductivity σ was calculated by

$$σ = \frac{l}{RA} \qquad ( 2 )$$

where σ is ionic conductivity of polymer electrolyte, and 1, R, and A represent the thickness, the bulk resistance, and the test area of polymer electrolyte, respectively.

With the use of the design principles, a family of AD-gel electrolyte with elastomeric coating was synthesized according to the proposed fabrication method (FIG. 2a). The morphology of the as-synthesized AD-gel was examined by SEM.

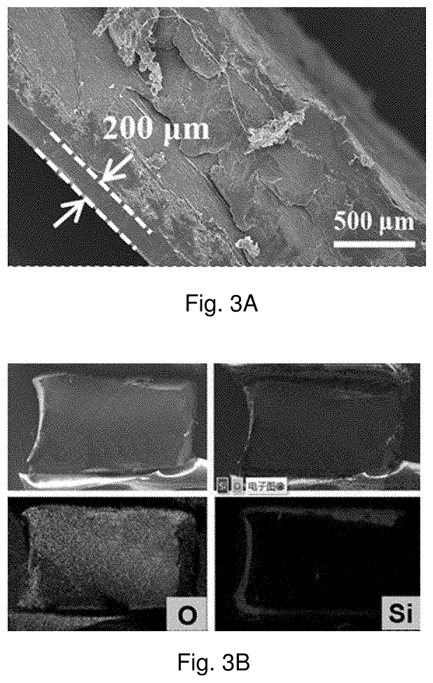

With reference to FIG. 3A, it is revealed that the AD-gel has a coating of approximately 200 μm. Cross-sectional SEM mapping and EDS results intuitively depict the conformal and continuous interface between organohydrogel matrix (i.e. Zn-alginate/PAM) and superficial coating (i.e. PDMS) with close contact. (FIG. 3B)

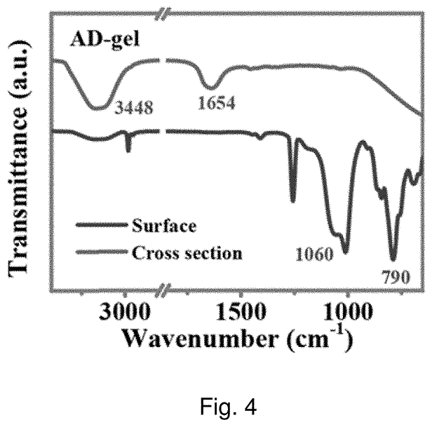

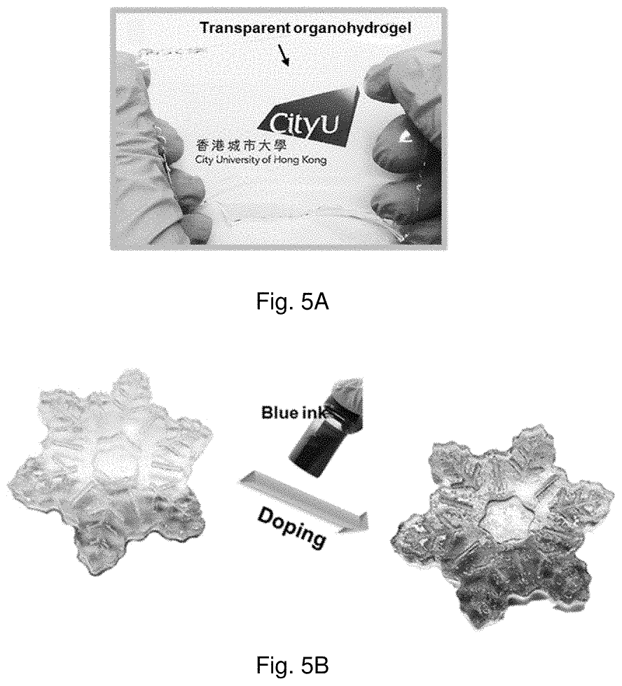

Fourier-transform infrared spectroscopy (FTIR) was performed to identify the components of the AD-gel (FIG. 4). Notably, the spectrum of the cross section of the AD-gel exhibited several absorption bands at 1654 cm⁻¹ (N—H stretching vibration) and 3448 cm⁻¹ (C═O stretching vibration), which were abscribed to the typical absorption bands of PAM gel matrix. Referring to the spectrum of the surface of the AD-gel, the characteristic peaks at 790 cm⁻¹ and 1060 cm⁻¹ were assigned to the Si—O stretching vibration of PDMS silane. These results confirm the existence of elastomeric coating onto the surface of the organohydrogel matrix. The synthesized AD-gel electrolyte exhibited a transparent state (FIG. 5A). For the ease of visualization, a blue ink was doped into precursors of the AD-gel prior to performing polymerization (FIG. 5B).

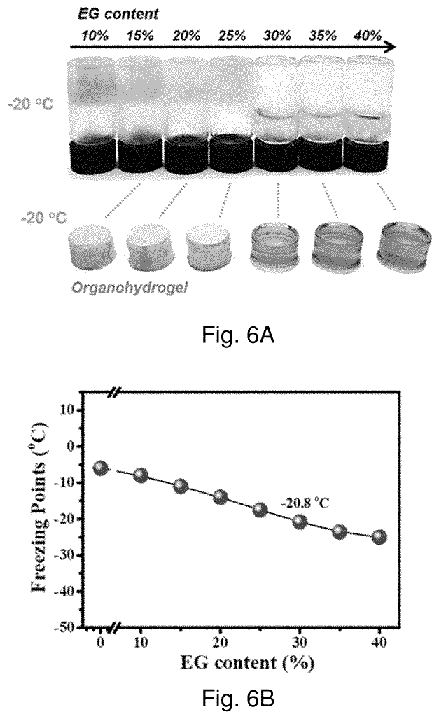

The freezing point of the AD-gel may be controlled by tuning the ethylene glycol (EG) weight contents as shown in FIGS. 6A and 6B. In general, the freezing point of the AD-gel decreases (i.e. becomes more negative) with an increase in the EG content. In particular, a freezing point of −20.8° C. was obtained with the use of 30 wt % of EG (FIG. 6B).

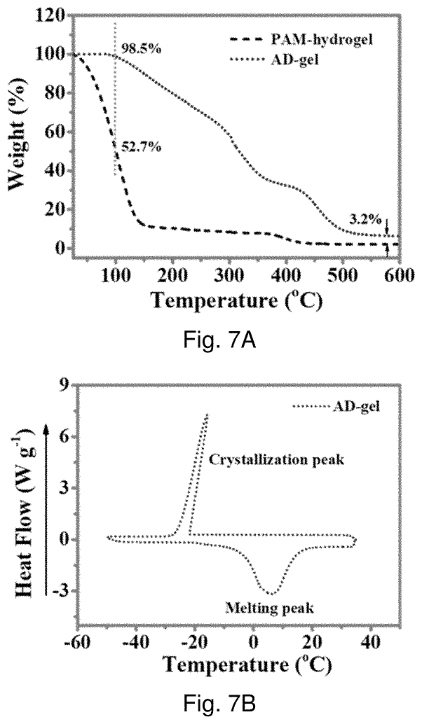

The results of thermodynamic test indicated that the elastomer (PDMS) coating can effectively prevent water evaporation over 120° C., while the normal PAM-hydrogel lost its weight approaching to its original water contents under the same conditions (˜80 wt %) (FIG. 7A). In addition, DSC analysis indicated that the crystallization tmeperature of the AD-gel was about −23° C., suggesting that the anti-freezing property of the AD-gel (FIG. 7B).

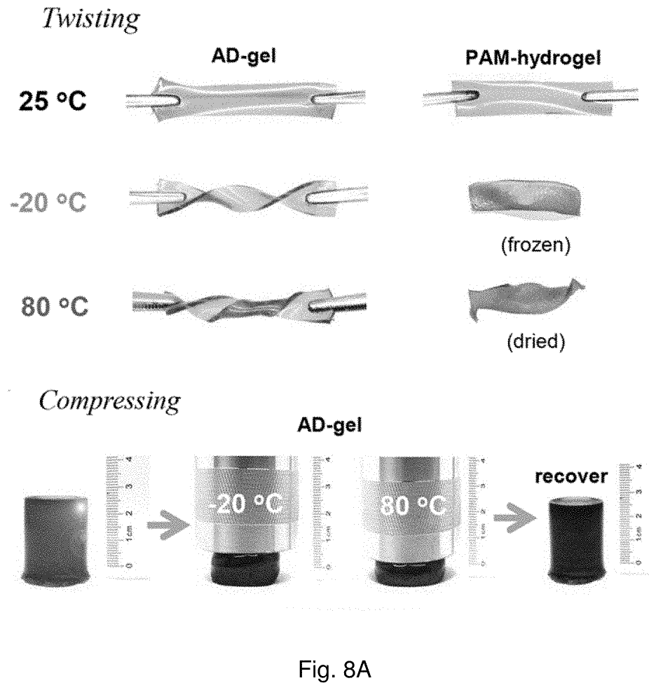

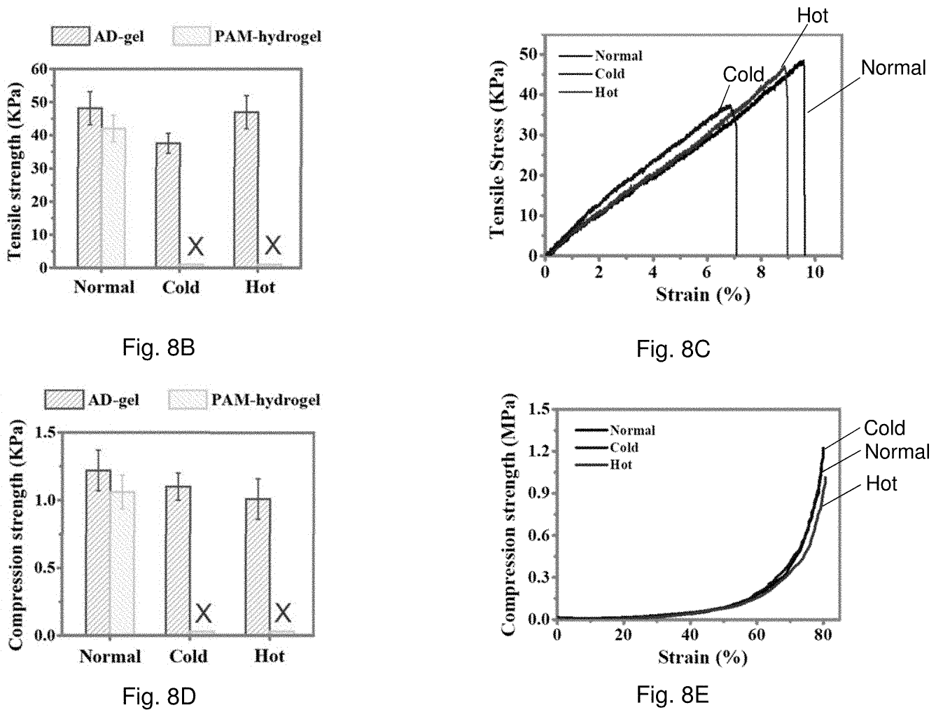

After storing the AD-gel at −20° C. or 80° C. for one day, the mechanical properties of the AD-gel were well persevered, exhibiting impressive flexibility to endure large deformations including twisting and compressing (FIG. 8A). Once the external force is withdrawn, the AD-gel quickly recovered from the deformed shapes, showing a high resilience. In sharp contrast, the PAM-hydrogel electrolyte was frozen into solid at −20° C., and dried out at 80° C. (FIG. 8A). Correspondingly, the quantified tensile strength and compression strength of the AD-gel electrolyte display similar value with subtle changes after cooling or heating, sharply contrasting with the appreciable deterioration in the mechanical properties of PAM-hydrogel electrolyte (FIGS. 8B to 8E).

The excellent temperature tolerance of the AD-gel electrolyte may be attributed to the synergistic effects elucidated as follows: (1) The non-volatile EG molecules existed in the gel network form strong hydrogen bonds with water molecules thereby disrupting the crystallization of ice at subzero temperatures, such disruption in turn depresses the freezing point of the organohydrogel. (2) The anti-dehydration elastomeric coating layer can prevent evaporation of water molecules from the inner gel matrix, endowing the organohydrogel with good consistency and durability at high temperatures.

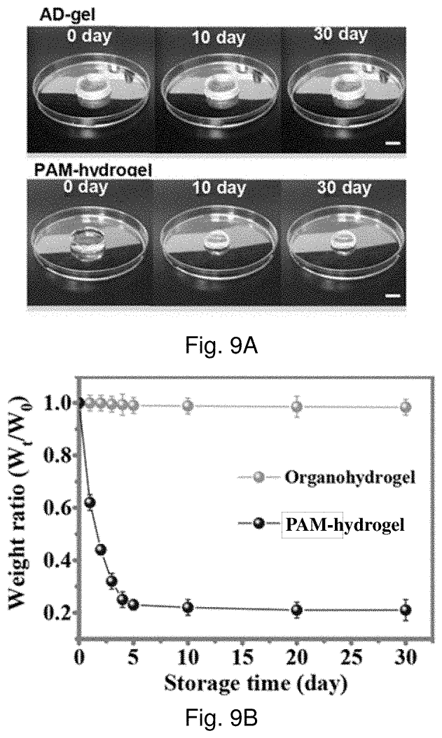

In terms of the long-term stability, dehydration test was carried out on the AD-gel and PAM-hydrogel electrolytes with the same dimensions. The test was performed at 25° C. and 50% humidity, and the weight retention of the AD-gel and PAM-hydrogel electrolytes was recorded at different time intervals. As illustrated in FIGS. 9A and 9B, the weight of AD-gel electrolyte was minorly drifted (<2%) even after 30 days of storage, whereas the PAM-hydrogel electrolyte lost most its weight after the initial 5 days and finally dried out to become a hard scaffold (FIG. 9A).

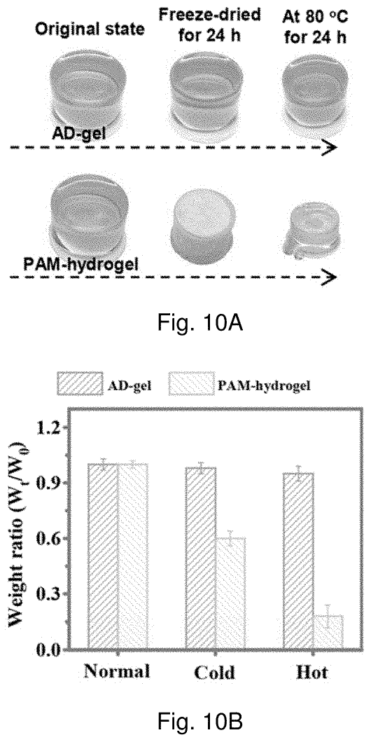

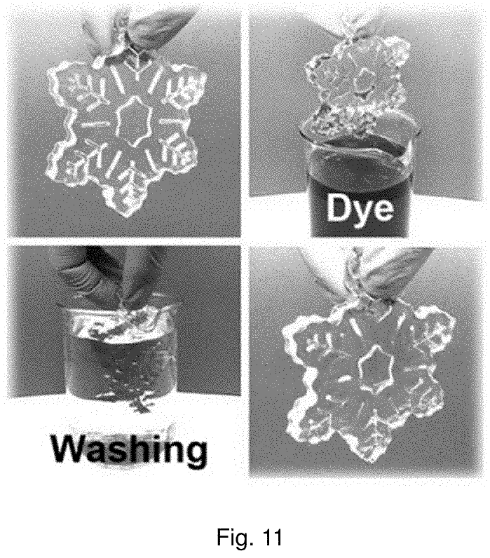

To further verify the anti-dehydration property of the AD-gel electrolyte, the AD-gel and PAM-hydrogel electrolytes were placed in a −20° C. freeze-dryer or a 80° C. oven for 24 h (FIG. 10A). The PAM-hydrogel was freeze-dried in cold or transformed into a dried bulk polymer in hot, while the AD-gel electrolyte remained soft and elastic in both the harsh conditions. As illustrated in FIG. 10B, it is also shown that the weight ratio of the PAM-hydrogel electrolyte was reduced to 0.6 and 0.3 under said cold and hot conditions, respectively. On the contrary, the weight ratio of the AD-gel remained unchanged under the same experimental conditions. This may be abscribed to the synergies of EG and elastomer coating of the AD-gel. In addition, an AD-gel electrolyte with arbitrary shape was immersed in a dye bath for 1 h. It was found that the color was readily washed away by clean water (FIG. 11). This result may reveal that the elastomer coating retards the mass exchange between the inner organohydrogel matrix with the outer environment. In other words, the coating may have perfectly sealed the hydrogel with arbitrary shape from external environment.

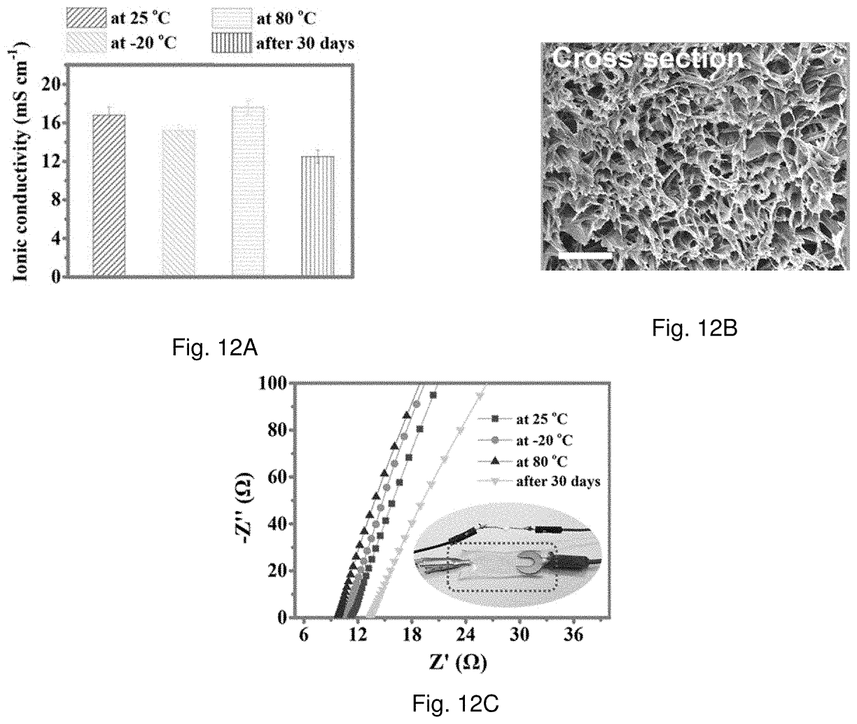

In order to measure the ionic conductivity of the AD-gel electrolyte, two plates of stainless steel were wrapped into the AD-gel electrolyte before the elastomer coating process. As shown in FIG. 12A, the ionic conductivity of AD-gel electrolyte containing 2 mol L⁻¹ of ZnSO₄ and 0.1 mol L⁻¹ of MnSO₄ was calculated to be 16.3 mS cm⁻¹, which was comparable to other ionic conducting polyelectrolytes with zinc ion as shown in Table 1 below.

TABLE 1
Ionic conductivity of AD-gel electrolyte and various
zinc salts-containing polyelectrolytes.

| | | Ionic Conductivity |
|---|---|---|
| Polyelectolytes | Zinc Salts | (mS cm⁻¹) |
| AD-gel electrolyte | ZnSO₄ | 16.3 |
| PAN | ZnSO₄ | 0.22 |
| Gelatin | ZnSO₄ | 5.68 |
| Fumed silica | ZnSO₄ | 8.1 |
| PCL | Zn(CF₃SO₃)₂ | 0.88 |
| PEO | ZnCl₂ | 2-4 |
| PVdF-HFP | ZnTf₂ | 3.82 × 10⁻³ |
| [Py_{1,4}]TfO-PVdF-HFP | Zn(TfO)₂ | 2.2 |
| AD-gel electrolyte | ZnSO₄ | 16.3 |

The ionic conductivity of the AD-gel maintained a similar value of 14.1 mS cm⁻¹ even at −20° C. (FIG. 12A). This may be ascribed to highly porous structure of the AD-gel under such temperature. As shown in FIG. 12B, the highly porous structure of the AD-gel was maintained after subjecting to freeze-dry for 24 h. The abundant microphores within the polymer matrix provides a large amount of channels for zinc ion transportation, rendering highly ionic conductivity of the AD-gel even under a low temperature.

The Ad-gel also possessed a higher value of ionic conductivity (18.2 mS cm⁻¹) at 80° C. as a result of increase in diffusion velocity of zinc ions at high temperature. Furthermore, no appreciable deterioration in the ionic conductivity was observed after 30 d of long-term storage in air (FIG. 12A). The stable electrochemical performance of the AD-gel under the aforesaid conditions was also observed in the AC impedance spectra as shown in FIG. 12C. All these results confirm the extremely temperature tolerance and anti-dehydration function of AD-gel electrolyte for long-term application.

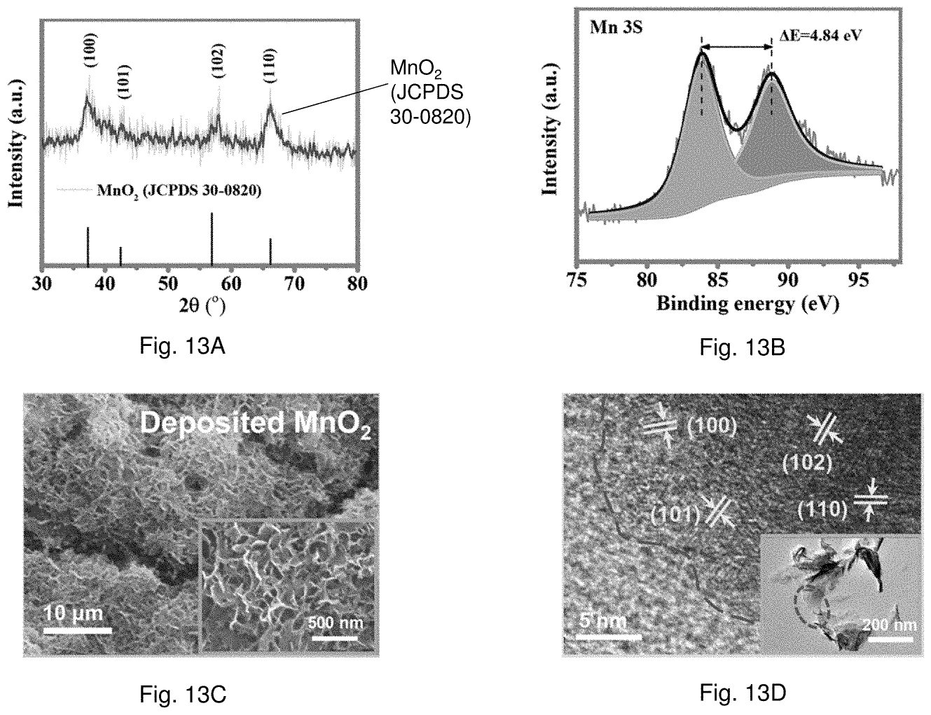

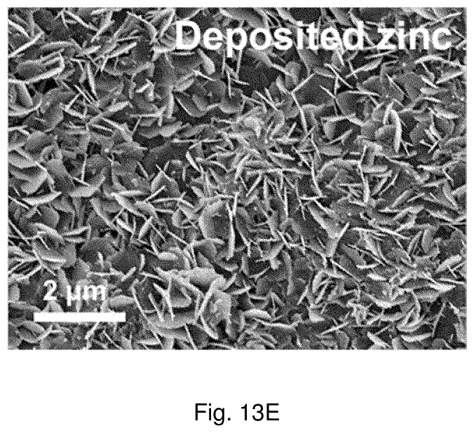

Preferably, a rechargeable Zn—MnO₂ battery containing the aforesaid AD-gel may be fabricated in accordance with the fabrication method as discussed, by combining electrodes with the fabricated AD-gel. Binder-free electrodes were prepared by an in-situ electrodeposition method, which can provide an intimate direct contact of Zn or MnO₂ with the current collectors such as stainless steel mesh (SS mesh). FIG. 13A showed the XRD pattern of a deposited MnO₂@SS mesh electrode, in which all characteristic peaks were well-indexed to Akhtenskite MnO₂ (JCPDS 30-0820).

The XPS results revealed that the spin-energy separation of the Mn 3 s doublet is 4.84 eV, indicating that the Mn element in the electrodeposited MnO₂ has a charge state of approximate 4.0 (FIG. 13B). The SEM images intuitively showed that the MnO₂ comprises a highly porous structure of interconnected nanoflakes (FIG. 13C). As depicted in the TEM images (FIG. 13D), the porous MnO₂ nanoflakes are polycrystalline consisting of nanograins with a size of approximately 10 nm. The SEM image of Zn anode, as given in FIG. 13E, showed that the electroplated zinc on the SS mesh existed as uniform porous nanosheet structure, which may facilitate the interfacial compatibility of electrode-electrolyte and enable a fast charge transport.

The inventors devise that many of the existing flexible electrical energy storage devices are of a sandwiched structure that includes two electrodes that sandwiches a layer of electrolyte. In such relatively simple structure, water molecules may easily evaporate from the exposed part of hydrogel electrolyte, or through the electrodes which may employ a carbon cloth as a current collector.

Preferably, the chemical elastomeric coating of the embodiments of the present invention prevents water evaporation from the exposed part of the hydrogel electrolyte. The electrolyte may also be applied to diverse flexible electrical energy storage devices.

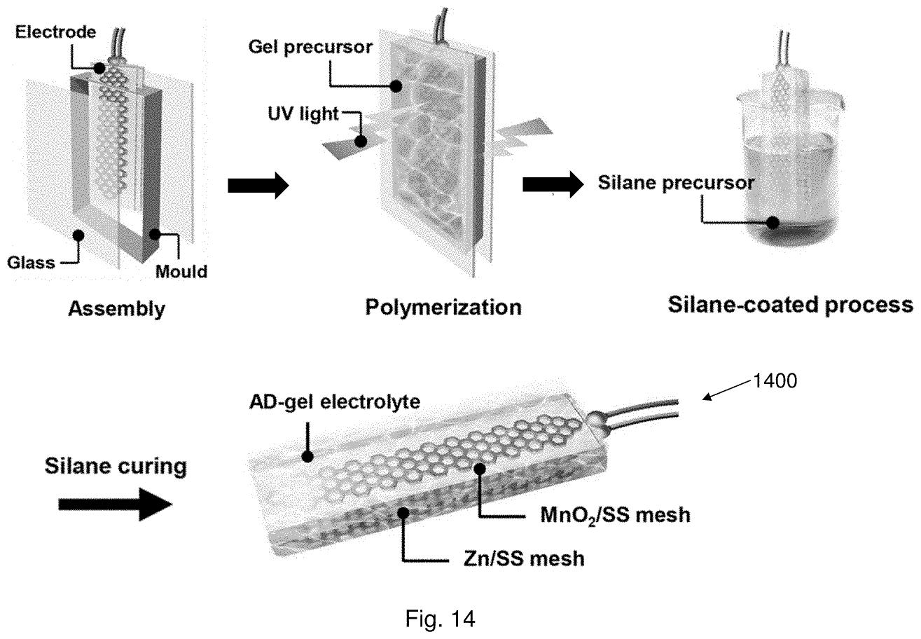

With reference to FIG. 14, a battery device 1400 having AD-gel electrolyte that provides excellent water retention property may be fabricated. In this embodiment, the electrodes are wrapped inside the polyelectrolyte. The manufacturing process of the rechargeable Zn—MnO₂ battery based AD-gel electrolyte (AD-battery) 1400 is schematically illustrated in FIG. 14. The prepared electrodes were first fixed nominally in the middle of two glass plates by utilizing a 2 mm thick silicone spacer which also serving as a reaction mould for polyelectrolyte. Next, a solution containing various precursors was injected into the reaction mould and an AD-gel electrolyte was obtained after the photo-induced free radical polymerization. After that, the elastomeric coating process of the as-prepared battery was performed by dipping the battery into a silane precursor solution for five times, followed by drying the battery in an oven. In addition, pure PAM-hydrogel electrolyte based Zn—MnO₂ battery (PAM-battery) was also fabricated as the control group.

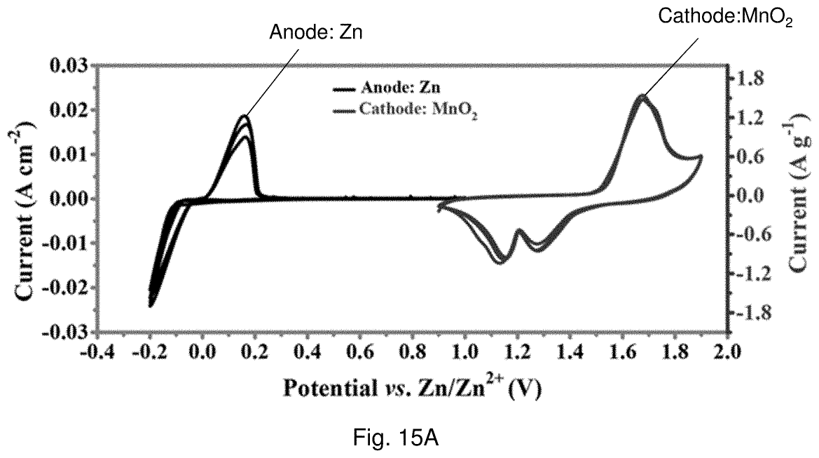

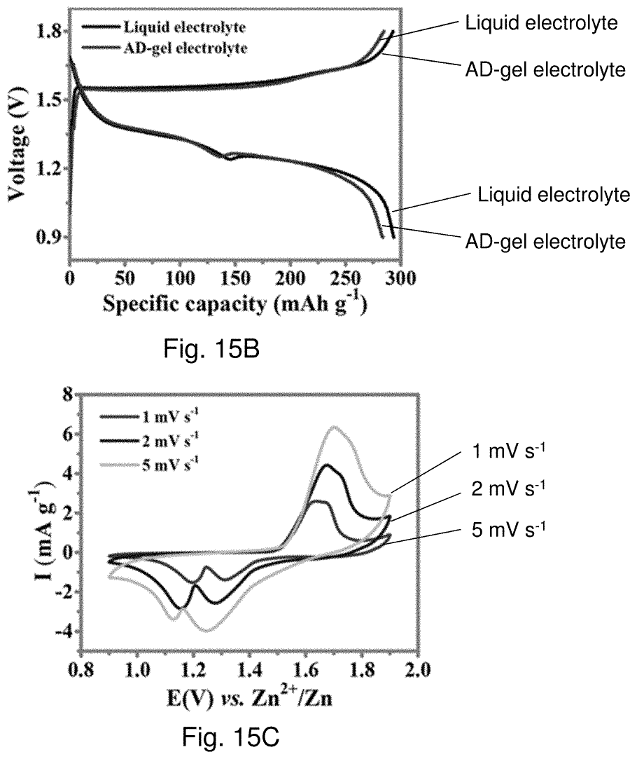

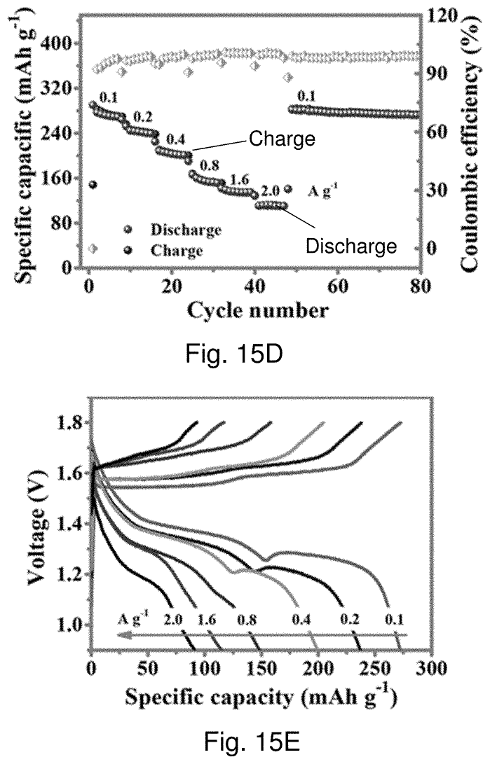

The electrochemical performance of the fabricated AD-battery 1400 under normal condition (25° C.) was investigated. As shown in FIG. 15A, the CV curves of Zn anode revealed that the plating/stripping of the deposited zinc is stable with nearly overlapped curves. For the deposited MnO₂ cathode, it is observed that two distinguishable redox peaks occur in the discharge/charge process and the CVs remained invariable after several cycles, demonstrating a good reversibility of the cathode.

As illustrated in FIG. 15B, the AD-battery 1400 delivered a high discharge capacity of 272 mAh g⁻¹ with two stable potential plateaus at a current density of 0.1 A g⁻¹. The corresponding CV curves also revealed two pairs of reduction/oxidation peaks, suggesting a two-step reaction (FIG. 15C).Furthermore, with the increasing scan rates from 1 to 5 mV s⁻¹, the CV curves exhibited similar shapes and gradual broaden peaks as a result of polarization.

The rate performance of the battery at different current densities is illustrated in FIG. 15D. The battery exhibited high discharge capacities of 273, 237, 198, 148, and 114 mA h g⁻¹ at 0.1, 0.2, 0.4, 0.8 and 1.6 A g⁻¹, respectively. After cycling back to 0.1 A g⁻¹, a discharge capacity of 270 mA h g⁻¹ was recovered and maintained afterwards (FIG. 15D). In addition, the Coulombic efficiencies of the battery was approaching to 100%. The volumetric energy density of the battery was found to be 26.88 mW h cm⁻³.

The corresponding charge-discharge curves at various current densities exhibited characteristic plateaus with relatively small voltage hysteresis, demonstrating the significant structural adaptability of the AD-battery upon delivering capacities at various currents (FIG. 15E).

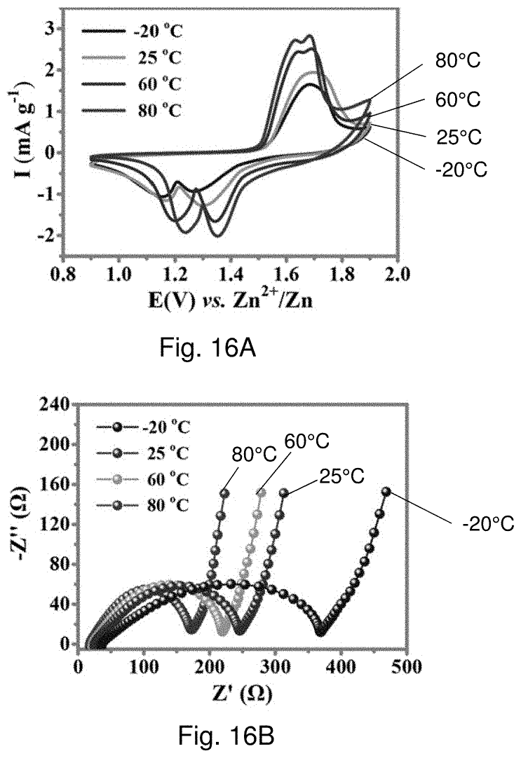

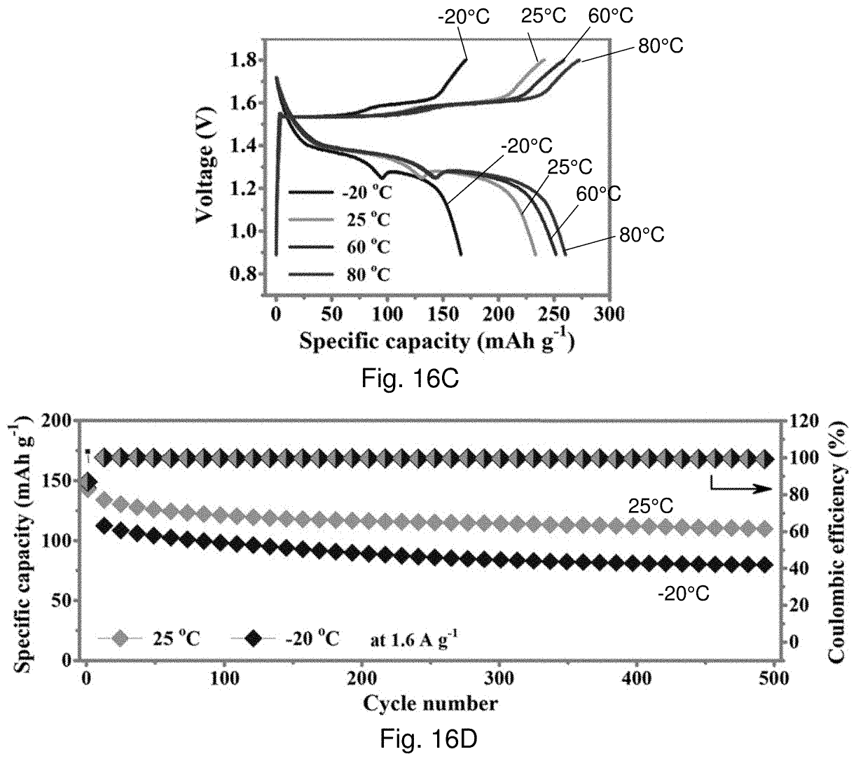

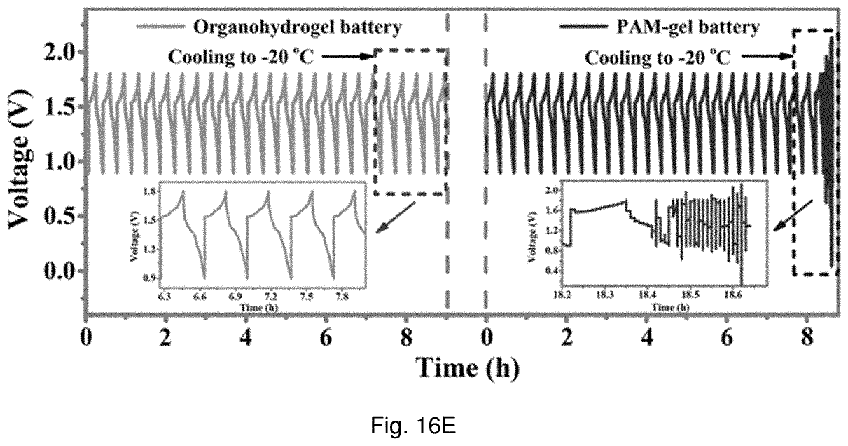

The real-time influence of temperature on the electrochemical performance of the battery 1400 was investigated by simulating the actual harsh conditions. The electrochemical properties of the battery were examined while the battery was operating inside a thermostat over the temperature ranged from −20° C. to 80° C. The CV curves of the AD-battery were recorded for several minutes at −20, 25, 60, and 80° C. As shown in FIG. 16A, all the CV curves exhibited distinguished reduction/oxidation peaks with negligible voltage polarization at the scan rate of 1 mV s⁺¹ , indicating an ideal reaction reversibility. The intensity of peaks after cooling or heating appears to increase slightly due to the integrity of the porous structure of the electrolyte at low temperature as discussed above as well as faster ion transport at high temperature.

Electrochemical impedance spectroscopy (EIS) plots of the AD-battery were also recorded at various temperatures (FIG. 16B). The impedance of the battery increased within a reasonable range from 164 Ω at 80° C. to 366 Ω at −20° C., revealing a stable ionic transport. These results confirm the excellent temperature durability and high compatibility of the electrodes and the AD-gel electrolyte.

Regarding to the charge/discharge stability of the AD-battery, the battery showed a stable rechargeability without evident voltage changes upon cooling and heating (FIG. 16C). Even at −20° C., the AD-battery still delivered a high specific capacity of 165 mA h g⁻¹ (˜70% of the one at 25° C.) at 0.2 A g⁻¹, manifesting the superior freeze-resistant property of the battery. At a high temperature, the discharge profiles appeared to almost overlap with that of 25° C. (FIG. 16C). These results indicate that the AD-battery can withstand a low temperature down to −20° C. and a high temperature up to 80° C.

For the cycling performance, at 25 and −20° C., the AD-battery exhibited 81% (124 mA h g⁻¹) and 66% (76 mA h g⁻¹) capacity retentions of its initial capacity over 500 cycles at 1.0 A g⁻¹ (capacity decay rates of 0.038% and 0.068% per cycle), respectively. The Coulombic efficiencies of the AD-battery remained as high as approximately 99.5-100.1% even at −25° C. (FIG. 16D). Moreover, the AD-battery presented a stable rechargeability without any obvious fluctuation, whereas the comparison PAM-hydrogel battery showed large augment of the voltage hysteresis upon cooling to −20° C. (FIG. 16E).

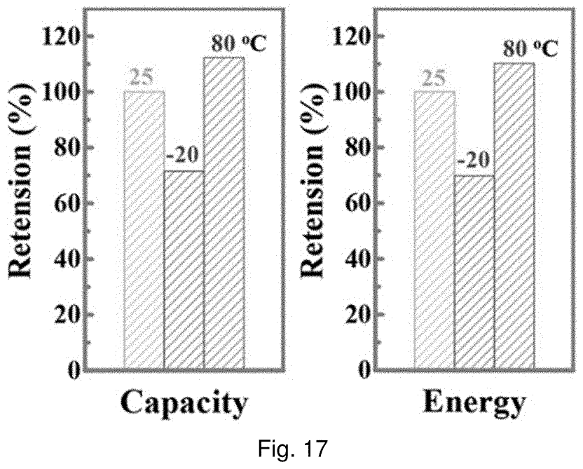

In addition, the variation of specific capacity with temperature (FIG. 17) indicated that the discharge capacity retentions of the AD-battery at −20° C. and 80° C. compared with that at 25° C. were 70% and 110%, respectively. The energy densities of the AD-battery at −20° C. and 80° C. were 65% and 108% retention of that at 25° C. (FIG. 17). The enhanced battery performance at 80° C. was mainly ascribed to the increase of ion transport kinetics in the electrolyte at high temperatures.

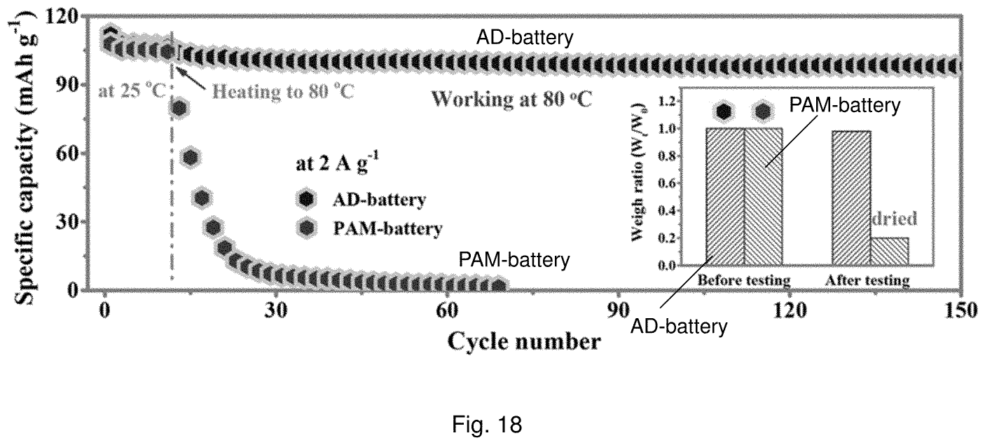

To verify the thermal stability, cycling tests were conducted on the AD-battery and PAM-battery in a thermostat. As shown in FIG. 18, the temperature was increased to 80° C. after first 5 cycles, the specific capacity of the PAM-battery deteriorated significantly with large voltage polarization. The performance degradation possibly resulted from the dehydration of hydrogel electrolyte at higher temperature (insert of FIG. 18). For the AD-battery, the energy-storage ability at 80° C. was almost the same as that prior to heating, and the specific capacity remained stable for the proceeding cycling, demonstrating the superior anti-heating property of the AD-battery (FIG. 18).

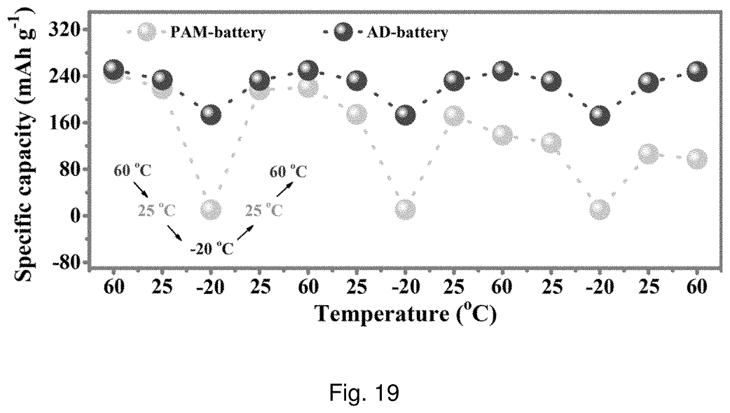

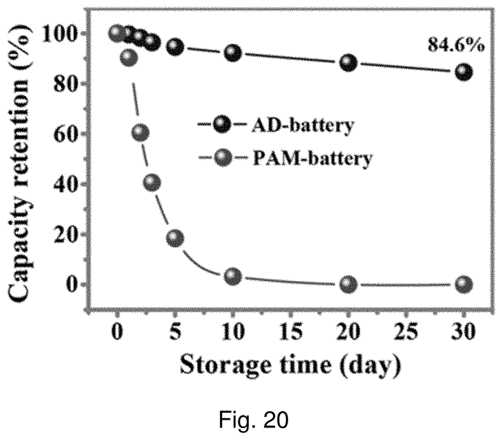

Experimental results of the AD-battery and PAM-battery cycled sequentially at 25, −20, and 60° C. are shown in FIG. 19. As the temperature fluctuates, the specific capacity of the AD-battery almost restored to the pristine one. After multiple cycles of cooling-heating-cooling process, no significant capacity attenuation was identified for the AD-battery, guaranteeing its practical application. The long-term stability of the AD-battery was demonstrated by a prolonged storage of the battery for 30 days. As shown in FIG. 20, the AD-battery exhibited 84.6% capacity retention after a prolonged storage of 30 days in normal condition (25° C.) whereas the PAM battery exhibited 0% capacity retention under the same experimental conditions.

Benefitting from its flexible components (the AD-gel, soft stainless steel mesh, and deposited active materials layer) as used, the AD-battery of the present disclosure possessed a high flexibility and architectural durability. As a demonstration of these properties, a series of experiments under extreme conditions including bending tests, soaking tests, anti-freezing evaluations and anti-heating of boiling water experiment were performed on the AD-battery.

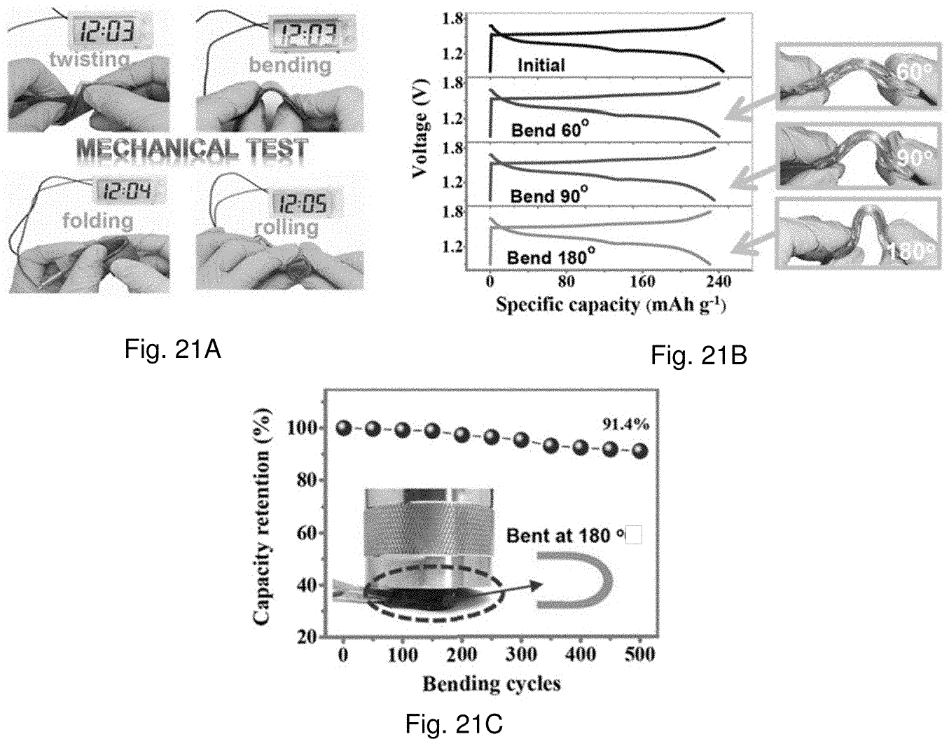

As shown in FIG. 21A, the battery was able to endure various extreme deformations of being twisted, bent, folded and rolled, while the battery was continually powering an electronic watch. At various bending states (60°, 90°, and) 180°, the corresponding galvanostatic charge/discharge characteristics could be well-preserved with subtle changes capacity change (FIG. 21B). Moreover, no appreciable deterioration in specific capacity was detected after 500 bending cycles at 180° (91.4% retention), confirming the superior stability of the AD-battery against various deformations (FIG. 21C).

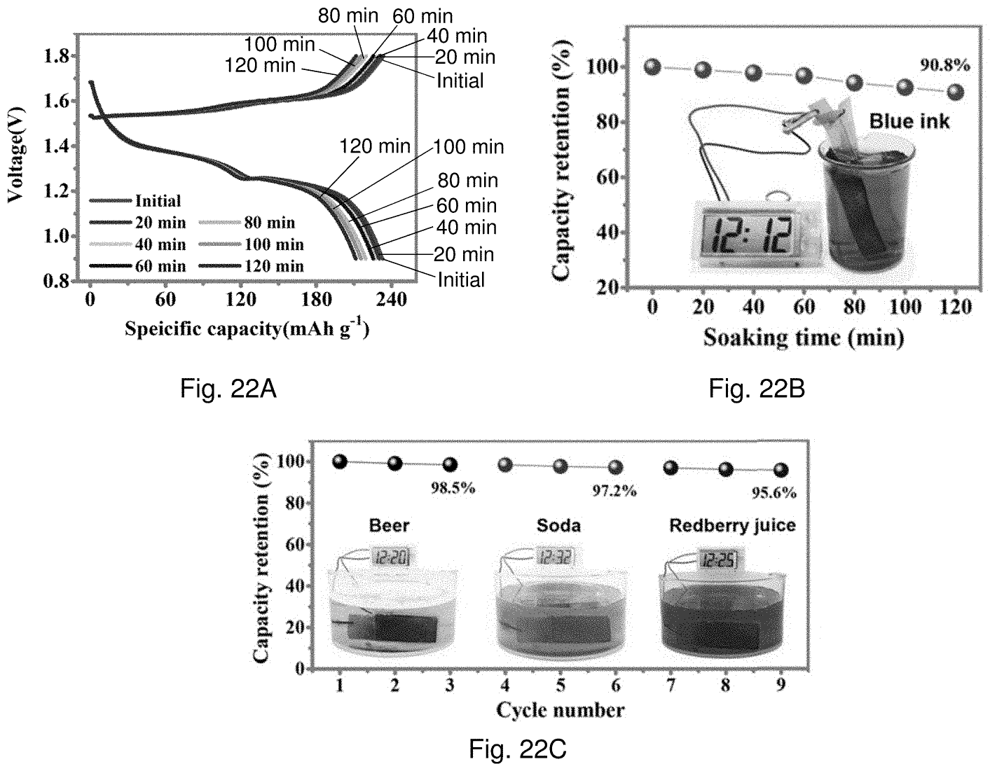

In the soaking tests, benefiting from the elastomeric coating, the fabricated AD-battery was endowed with excellent waterproof property. After being immersed in water for 120 min, the AD-battery retained approximately 90.8% retention of its initial specific capacity with no appreciable deterioration and continuously powered an electronic watch (FIGS. 22A and 22B). In addition to operating in water, the AD-battery was well operable under various beverages, such as beer, soda and berry juice, etc. (FIG. 22C). These results further confirm that the elastomeric coating retards the mass exchange between the inner organohydrogel matrix with the outer environment.

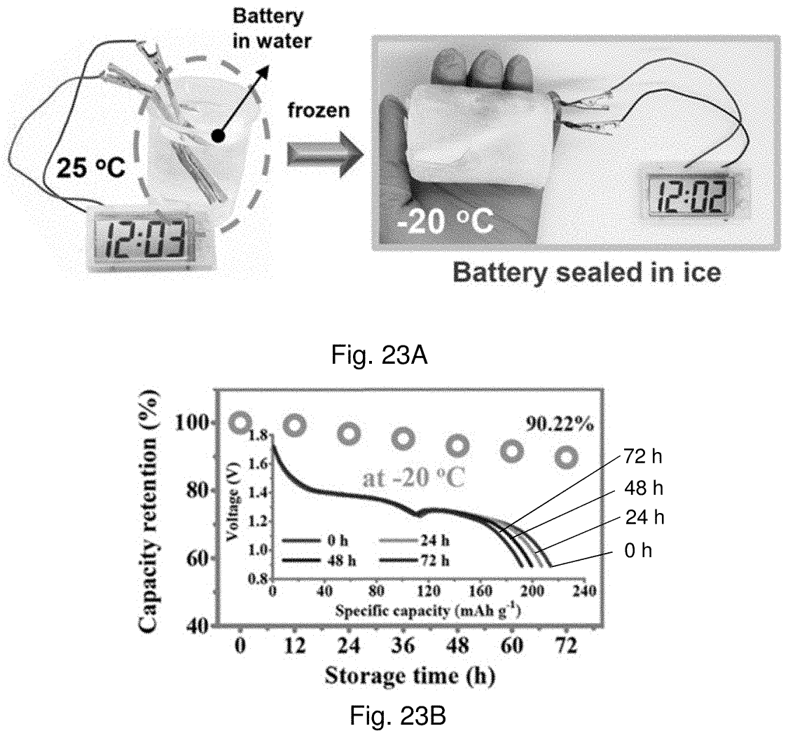

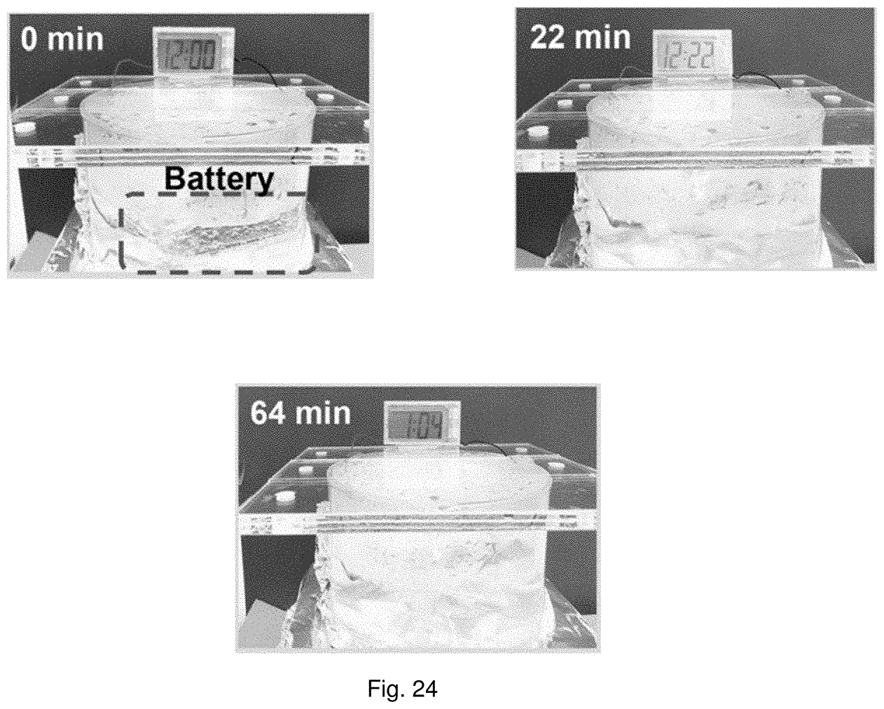

Freeze-resistant performance and thermal durability are of paramount importance for practical applications of solid-state batteries working in harsh environment. In light of this, the anti-freezing property of the battery was verified. The battery was immersed in water in a glass vessel and stored at −20° C. to form an ice solid. As shown in FIG. 23A, the ice-solid battery was still capable to power the electronic watch, and its specific capacity was well-retained over 90.22% after 72-hour storage at −20° C. (FIG. 23B). Moreover, when the battery was immersed in boiling water, it was still able to power an electric watch for at least 64 min (FIG. 24), demonstrating the impressive anti-heating property of the battery.

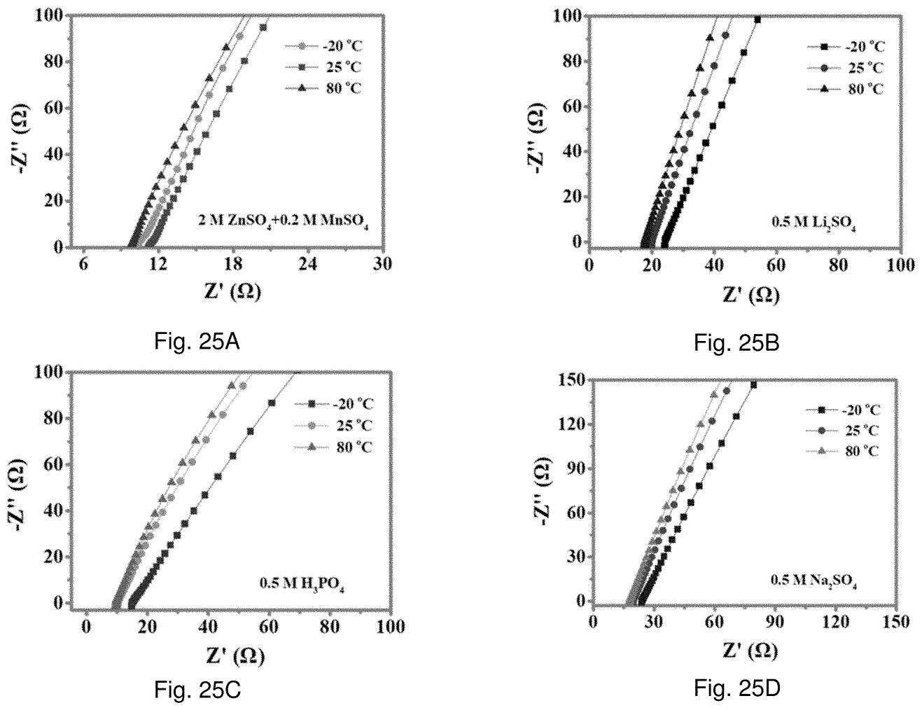

The AC impedance spectra given in FIGS. 25A to 25D indicated that the AD-gel electrolyte exhibited high ionic conductivity when containing different ions, such as Zn²⁺, Li⁺, H⁺, and Na⁺ions, implying the promising compatibility of the AD-gel electrolyte to other energy storage devices. As an demonstration, the AD-gel electrolyte was integrated into another battery system of Zn—LiMn₂O₄ battery (Zn-LMO battery).

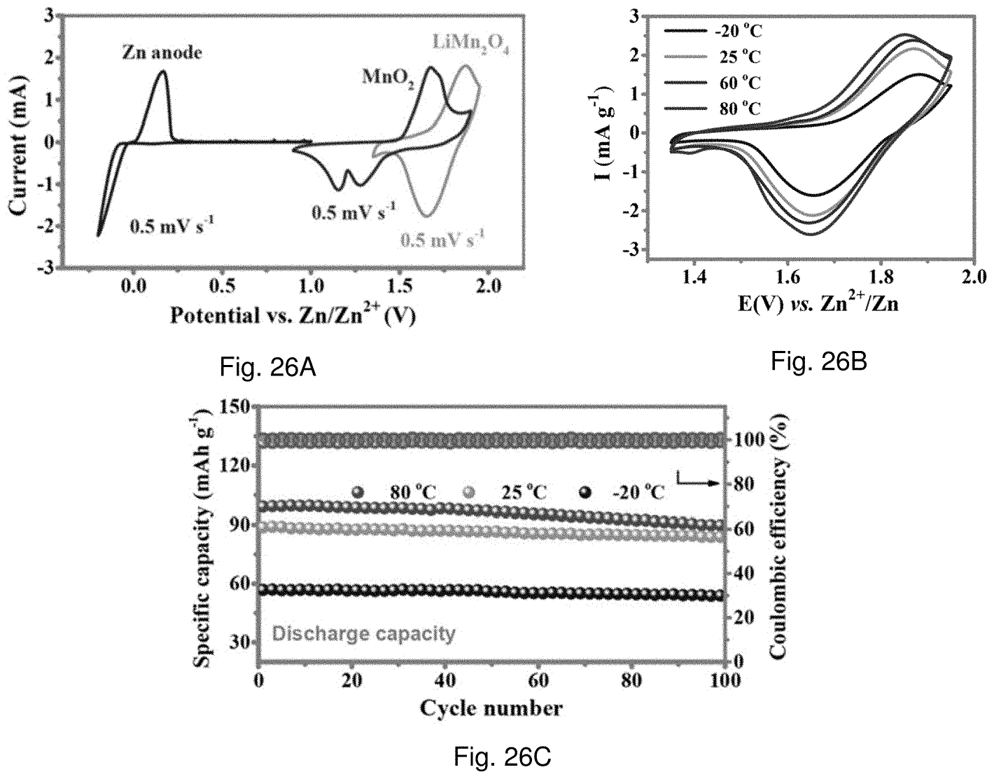

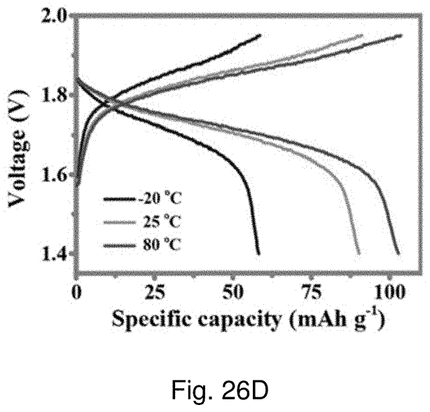

As shown in FIG. 26A, the Zn-LMO battery exhibited evident reversible redox peaks with higher potential than those of Zn−MnO₂ battery system. For cycling performance of the ZN-LMO battery at different temperatures, it delivered a capacity of 90 mA h g⁻¹ at 0.3 A g⁻¹ with a retention of 97.56% of its initial capacity after 100 cycles at 25° C. A high cycling stability to temperature is also manifested for the Zn-LMO battery with 89.52% (80° C.) and 91.17% (−20° C.) capacity retentions after 100 cycles at 0.3 A g⁻¹, respectively (FIGS. 26B to 26D).

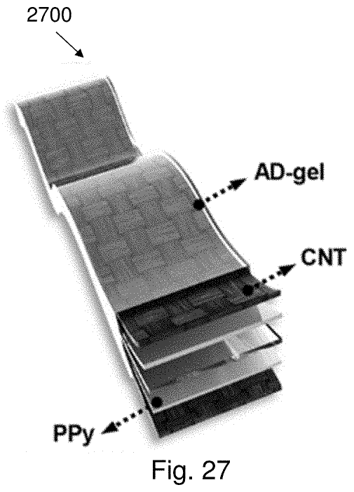

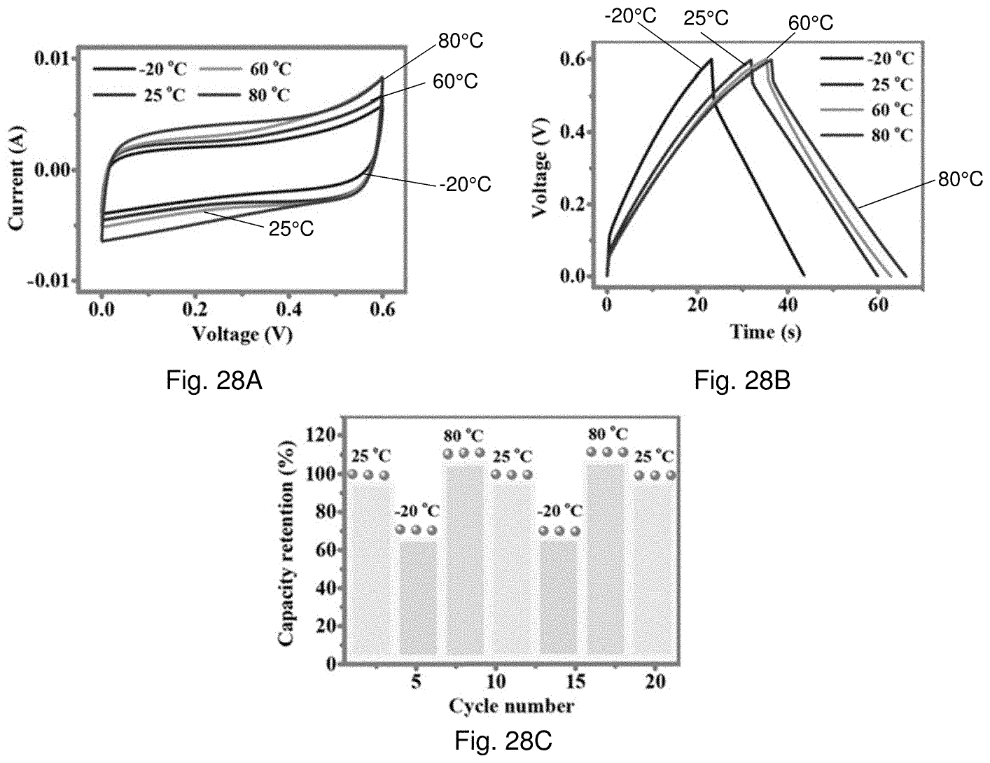

With reference to FIG. 27, an alternative embodiment of the present invention is provided. In this example, the energy storage is a supercapacitor, such as a symmetrical supercapacitor 2700. The capacitor 2700 comprises the AD-gel electrolyte and a pair of carbon nanotube paper/polypyrrole (CNT@PPy) electrodes was fabricated. Capacitive behaviors of the supercapacitor 2700 were investigateded over the temperature range from −20° C. to 80° C. through CV and GCD profiles (FIGS. 28A and 28B). As shown in FIG. 28A, all the CV curves were of close-rectangular shape in all temperature scale, suggesting good ionic conductivity of the AD-gel electrolyte at extreme temperatures.

The capacitance of the supercapacitor 2700 after subjecting to heating and cooling cycles between −20° C., 25° C., and 80° C., appeared to be almost same as the one at 25° C. (FIG. 28C). These results demonstrated the promising applications of AD-gel electrolyte in diverse electrical energy storage devices.

The electrical energy storage device of the present invention such as the battery 100/100′ is advantageous since it is adapted to different harsh and extreme conditions while the electrochemical performance of the device is maintained. For example, the battery has a capacity retention of 84.6% when the battery is operated at 80° C. Even operating at −20° C., the battery is still capable of delivering a capacity retention of 70%. The battery is also operable to power a digital timer when the battery is immersed in boiling water or sealed in ice. All these features suggest the excellent applicability of the electrical energy storage device of the present invention.

In addition, on the one hand, the device is highly flexible/soft, rendering it arbitrarily deformable into various irregular shapes as well as the excellent wearing compatibility. On the other hand, the device has a high resistance to different mechanical deformations, such as twisting, rolling, folding, and bending while showing stable electrochemical performance.

Furthermore, the scaling up of the device is very cost effective and simple as it does not require a water-free and/or oxygen-free environment for assembling the battery.

The description of any of these alternative embodiments is considered exemplary. Any of the alternative embodiments and features in the alternative embodiments can be used in combination with each other or with the embodiments described with respect to the figures.

The foregoing describes only a preferred embodiment of the present invention and modifications, obvious to those skilled in the art, can be made thereto without departing from the scope of the present invention. While the invention has been described with reference to a number of preferred embodiments it should be appreciated that the invention can be embodied in many other forms.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An electrolyte for use in an electrical energy storage device, comprising:
a hydrogel and an electrolytic solution retained by the hydrogel; and
a polymeric layer substantially encapsulating the hydrogel and forming at least one crosslinked structure with the hydrogel;
wherein the polymeric layer is arranged to prevent water escaping from the hydrogel structure.

2. The electrolyte for use in an electrical energy storage device according to claim 1, wherein the at least one crosslinked structure of the polymeric layer includes a first crosslinked structure defined by a plurality of polymer chains of a first polymeric material that form at least one covalent bond with the hydrogel.

3. The electrolyte for use in an electrical energy storage device according to claim 2, wherein the hydrogel comprises a polymer matrix including at least two crosslinked structures having a second polymeric material and a third polymeric material.

4. The electrolyte for use in an electrical energy storage device according to claim 3, wherein the plurality of polymer chains of the first polymeric material are functionalized with a first coupling agent such that the polymer chains of the first polymeric material form a covalent bond with a plurality of polymer chains of the second polymeric material defining a second crosslinked structure of the at least two crosslinked structures of the polymer matrix.

5. The electrolyte for use in an electrical energy storage device according to claim 4, wherein the first coupling agent includes triethoxy(vinyl)silane (TEOVS).

6. The electrolyte for use in an electrical energy storage device according to claim 2, wherein the first polymeric material is polydimethylsiloxane (PDMS).

7. The electrolyte for use in an electrical energy storage device according to claim 4, wherein the plurality of polymer chains of the second polymeric material are functionalized with a second coupling agent for coupling with the first coupling agent.

8. The electrolyte for use in an electrical energy storage device according to claim 7, wherein the second coupling agent includes 3-(trimethoxysilyl)propyl methacrlate (TMSPMA).

9. The electrolyte for use in an electrical energy storage device according to claim 4, wherein the second crosslinked structure is defined by the plurality of polymer chains of the second polymeric material that form a chemical crosslink and/or a physical crosslink between each adjacent pair of polymer chains of the second polymeric material.

10. The electrolyte for use in an electrical energy storage device according to claim 9, wherein the chemical crosslink includes at least one covalent bond formed at a bonding site between the adjacent pair of polymer chains of the second polymeric material.

11. The electrolyte for use in an electrical energy storage device according to claim 10, wherein the chemical crosslink further includes a first crosslinking agent forming the at least one covalent bond with the adjacent pair of polymer chains of the second polymeric material.

12. The electrolyte for use in an electrical energy storage device according to claim 11, wherein the first crosslinking agent is N,N′-methylenebisacrylamide.

13. The electrolyte for use in an electrical energy storage device according to claim 9, wherein the physical crosslink includes a second crosslinking agent forming at least one hydrogen bond with the adjacent pair of polymer chains of the second polymeric material.

14. The electrolyte for use in an electrical energy storage device according to claim 13, wherein the second crosslinking agent includes ethylene glycol.

15. The electrolyte for use in an electrical energy storage device according to claim 3, wherein the at least two crosslinked structure includes a third crosslinked structure defined by a plurality of polymer chains of the third polymeric material that form an ionic crosslinked between at least one adjacent polymer chain of the third polymeric material.

16. The electrolyte for use in an electrical energy storage device according to claim 15, wherein the ionic crosslink includes at least one ionic bond formed at a bonding site between the adjacent pair of polymer chains of the third polymeric material.

17. The electrolyte for use in an electrical energy storage device according to claim 16, wherein the ionic crosslink further includes a third crosslinking agent forming the at least one ionic bond with the adjacent pair of polymer chains of the third polymeric material.

18. The electrolyte for use in an electrical energy storage device according to claim 15, wherein the third crosslinking agent includes a cation.

19. The electrolyte for use in an electrical energy storage device according to claim 3, wherein the second polymeric material is polyacrylamide.

20. The electrolyte for use in an electrical energy storage device according to claim 3, wherein the third polymeric material is alginate.

21. The electrolyte for use in an electrical energy storage device according to claim 1, wherein the electrolytic solution includes at least one salt or acid having a concentration of 0.1-3M.

22. An electrical energy storage device, comprising:
an anode and a cathode being spaced apart from each other;
an electrolyte disposed between the anode and the cathode, the electrolyte comprises a hydrogel and an electrolyte retained by the hydrogel; and
a polymeric layer substantially encapsulating the hydrogel and forming at least one crosslinked structure with the hydrogel;
wherein the polymeric layer is arranged to prevent water escaping from the hydrogel structure.

23. The electrical energy storage device according to claim 22, wherein the anode includes zinc metal or polypyrrole.

24. The electrical energy storage device according to claim 23, wherein the zinc metal includes electrodeposited zinc having a plurality of nanosheets forming a porous nanostructure facilitating charge transport.

25. The electrical energy storage device according to claim 22, wherein the cathode includes MnO₂, LiMn₂O₄ or polypyrrole.

26. The electrical energy storage device according to claim 25, wherein the MnO₂ includes electrodeposited MnO₂ having a plurality of interconnected nanoflakes forming a porous nanostructure.

27. The electrical energy storage device according to claim 22, wherein each of the electrodes further include an encapsulation having the second and the third polymeric materials enclosing the electrodes.

28. The electrical energy storage device according to claim 22, wherein the at least one crosslinked structure of the polymeric layer includes a first crosslinked structure defined by a plurality of polymer chains of the first polymeric material that form at least one covalent bond with the hydrogel.

29. The electrolyte for use in an electrical energy storage device according to claim 28, wherein the hydrogel comprises a polymer matrix including at least two crosslinked structures having a second polymeric material and a third polymeric material.

30. The electrical energy storage device according to claim 29, wherein the plurality of polymer chains of the first polymeric material are functionalized with a first coupling agent such that the polymer chains of the first polymeric material further form a covalent bond with a plurality of polymer chains of the second polymeric material defining a second crosslinked structure of the at least two crosslinked structures of the polymer matrix.

31. The electrical energy storage device according to claim 30, wherein the plurality of polymer chains of the second polymeric material are functionalized with a second coupling agent for coupling with the first coupling agent.

32. The electrical energy storage device according to claim 30, wherein the first crosslinked structure is defined by the plurality of polymer chains of the second polymeric material that form a chemical crosslink and/or a physical crosslink between each adjacent pair of polymer chains of the second polymeric material.

33. The electrical energy storage device according to claim 29, wherein the at least two crosslinked structure includes a third crosslinked structure defined by a plurality of polymer chains of the third polymeric material that form an ionic crosslinked between at least one adjacent polymer chain of the third polymeric material.

34. The electrical energy storage device according to claim 22, wherein the polymeric layer is arranged to reduce exchange of material between the electrolyte and an external environment, thereby preventing water escaping from the hydrogel structure.

35. The electrical energy storage device according to claim 22, wherein the device is a rechargeable battery or a supercapacitor.

36. A method of preparing an electrical energy storage device comprising the steps of:
a) forming an anode;
b) forming a cathode;
c) forming an electrolyte comprising a polymer matrix;
d) sandwiching the electrolyte between the anode and the cathode;
wherein the electrolyte is arranged to prevent water escaping therefrom.

37. The method of preparing an electrical energy storage device according to claim 36, wherein the step c) of forming an electrolyte comprising a polymer matrix includes the steps of:
forming a mixture of a first gel monomer, an initiator, a first crosslinking agent, a second crosslinking agent, and a first coupling agent;
adding an alginate into the mixture to form a blend;
curing the blend at room temperature or a higher temperature; and
soaking the cured blend in an aqueous electrolytic solution.

38. The method of preparing an electrical energy storage device according to claim 37, wherein the first gel monomer is acrylamide, the initiator is ammonium persulfate, the first crosslinking agent is N,N′-methylenebisacrylamide, the second crosslinking agent is ethylene glycol, and the first coupling agent is 3-(trimethoxysilyl)propyl methacrlate (TMSPMA).

39. The method of preparing an electrical energy storage device according to claim 37, wherein the aqueous electrolytic solution includes at least one of a salt, an acid or a surfactant.

40. The method of preparing an electrical energy storage device according to claim 36, wherein the step a) of forming an anode includes the step of electrodepositing zinc metal on a substrate.

41. The method of preparing an electrical energy storage device according to claim 36, wherein the step b) of forming a cathode includes the step of depositing an active material on a substrate.

42. The method of preparing an electrical energy storage device according to claim 41, wherein the active material includes MnO₂, LiMn₂O₄ and polypyrrole.

43. The method of preparing an electrical energy storage device according to claim 36, wherein the steps a) and b) include the step of encapsulating the electrodes with the electrolyte.

44. The method of preparing an electrical energy storage device according to claim 36, wherein the method further includes the step of, after step d), encapsulating the sandwiched structure with a polymeric layer.

45. The method of preparing an electrical energy storage device according to claim 44, wherein the step of encapsulating the sandwiched structure with a polymeric layer includes the step of immersing the sandwiched structure into a solution of silane-modified polydimethylsiloxane (PDMS).
